(19) United States
(12) Patent Application Publication
(10) Pub. No.: US 2014/0272894 A1
(43) Pub. Date: Sep. 18, 2014

(54) SYSTEM AND METHOD FOR MULTI-LAYERED EDUCATION BASED LOCKING OF ELECTRONIC COMPUTING DEVICES

(71) Applicant: Edulock, Inc., Reno, NV (US)

(72) Inventors: Patrick M. Grimes, Reno, NV (US); Linda S. Grimes, Reno, NV (US); Cody M. Grimes, Reno, NV (US)

(73) Assignee: Edulock, Inc., Reno, NV (US)

(21) Appl. No.: 14/203,405

(22) Filed: Mar. 10, 2014

Related U.S. Application Data
(60) Provisional application No. 61/778,988, filed on Mar. 13, 2013.

(51) Int. Cl. G09B 5/08

(52) U.S. Cl. CPC G09B 5/08
USPC 434/350

(57) ABSTRACT

Systems, methods and computer program products for managing multi-layer rewards and multi-device control in reward-based learning experiences for users having mobile electronic devices. These technologies require that a user complete education modules using his or her mobile electronic device before receiving a reward, such as access of certain features of the mobile electronic device, one layer at a time. A more difficult education module and a bigger reward may be associated with a higher layer. These technologies also ensure that when a user has a plurality of mobile electronic devices, the user may complete an education module on one or more of these electronic devices and the user would not receive a reward from any of these electronic devices until the user has completed the education module.

### RELATED APPLICATIONS

The present application claims priority to and benefit from U.S. Provisional Patent Application No. 61/778,988, titled “System and Method for Multi-layered Education Based Locking of an Electronic Computing Devices” and filed on Mar. 13, 2013. The present application is also related to U.S. Provisional Patent Application No. 61/782,006, titled “Method and System for Integrated Reward System for Education,” filed Mar. 14, 2013, U.S. Provisional Application No. 61/777,178, titled “System and Method for Instruction Based Access to Electronic Computing Devices,” filed Mar. 12, 2013, and U.S. Provisional Application No. 61/775,623, titled “System and Method for a Comprehensive Integrated Education System (CIES),” filed Mar. 10, 2013. The entire contents of the aforementioned applications are herein expressly incorporated by reference.

### FIELD OF THE INVENTION

The present invention relates to control of access to an electronic computing device by a third party that requires the user to accomplish educational based objectives in order to activate the device, and then to gain access to specific functions/programs on the device for a specific period of time and further to maintain access for an extended time.

### BACKGROUND OF THE INVENTION

Researchers from around the globe agree that social media conducted via electronic computing devices, such as smartphones, is highly addictive and can be similar to drug addiction. In general, a techno-addict is an individual who is addicted to the use of electronic computing devices (e.g., television, interactive video game, Internet searching, emailing, texting, chatting, twittering, etc.). As they continue staring at the screen, their physical reaction helps their brain focus on the incoming mental stimuli because of the release of the neurotransmitter dopamine that provides them a feeling of euphoria (e.g., the reward for engaging in the activity), while also driving the craving of the activity.

The brain's release of dopamine is one of the many changes that can occur in the human brain when one processes a reward in exchange for a particular action. However, as it relates to a learning process, differences in the brain activities between individuals create the need to have a flexible system because students process the exchange of an action for a reward differently. In addition, with the explosion of new computer and mobile applications (i.e., apps) that can disguise and hide the ultimate purpose of a given electronic computing device's software application, a third party, such as a parent, needs help in controlling or monitoring the computer and mobile applications used by their children that facilitate the use of social media, entertainment and communications. Therefore, it would be useful to provide a technology that would cater to a user's preferences in reward-based learning processes while preventing the user from being over-addictive to the use of various electronic devices or otherwise abusing the opportunity to access these electronic devices.

### SUMMARY OF THE INVENTION

Various embodiments disclose systems, methods and computer program products for controlling access functions and features of one or more electronic computing devices by a third party administrator who is monitoring a user.

In some embodiments, a multi-device control system, which communicates with a plurality of client devices through a cloud-computing platform, performs the following method. It receives a first request for a first reward from a first of the plurality of client devices. In response, it transmits a task to the first client device. Subsequently, it receives a task performance result from the first client device. It then determines whether the received task performance result matches an expected task performance result for the transmitted task. When the determination result is positive, it delivers the first reward to the first client device. If it receives a second request for a second reward from a second of the plurality of client devices after the first request is received and before the first reward is delivered to the first client device, it notifies the second client device that the second reward is unavailable.

In some embodiments, a multi-device control system, which communicates with a plurality of devices through a cloud-computing platform, comprises the following features: a marking unit configured to mark all parts of a task unfinished; a transmitting unit configured to transmit the task to all the devices; an update unit configured to receive an update that a portion of the task is finished from a first of the devices; a determining unit configured to determine whether any part of the portion is marked unfinished and whether the task is completed; a notifying unit configured to, when the determination result indicates that the task is completed, inform all the devices that the task is completed and a reward is available, and when the determination result indicates that at least one part of the portion is marked unfinished, mark the at least one part finished and notify all the devices that parts of the task are finished.

In some embodiments, a device which communicates with a multi-device control server though a cloud-computing platform, comprises the following features: a task receiving unit configured to receive a task from the multi-device control server; a first update unit configured to receive a first update from the multi-device control server that a portion of the task is finished; a progress unit configured to allow a user to work on an unfinished portion of the task; a notifying unit configured to notify the multi-device control server that a portion of the task worked on by the user is now finished; and a second update unit configured to receive a second update from the multi-device control server that the task is completed and a reward is available.

In some embodiments, a device management system performs the following method to control access of a plurality of smart mobile devices of a user using a hierarchy of rewards. It sets the reward at the first level of the hierarchy to be an authorization for access of a native function of a first of the smart mobile devices. It also associates a reward at each level of the hierarchy with a task. It then transmits the task associated with the reward at a current level to one of the smart mobile devices only after delivering the reward at a previous level. It delivers the reward at a current level to one of the smart mobile devices only after the task associated with the reward at the current level is completed by the user.

### BRIEF DESCRIPTION OF THE DRAWINGS

The above and other features, aspects, and advantages of the present invention will become better understood with regard to the following description, appended claims, and accompanying drawings where:

FIG. 1 is a diagram illustrating an example environment in which a device management system manages access of electronic devices individually or in synchronization.

FIG. 2 is a block diagram illustrating example components of a device management system.

FIG. 3 is a user interface diagram illustrating examples of deploying the device management software on a user's electronic device.

FIG. 4 is a table diagram illustrating a multi-layered access protocol for an employee's electronic device instituted by an employer compared with a lack of access protocol for the employee's electronic device.

FIG. 5 is a table diagram illustrating a multi-layered access protocol for a user's electronic device instituted by a supervisor compared with a lack of access protocol for user's electronic device.

FIG. 6 is a user interface diagram illustrating a multi-layered access of a user's electronic device.

FIG. 7 is a flowchart diagram illustrating an example process managed by the device management system to execute a multi-layered access protocol.

FIG. 8 is a flowchart diagram illustrating another process performed by the device management system to execute a multi-layered access protocol.

FIG. 9 is a flowchart diagram illustrating another process managed by the device management system to execute a multi-layered access protocol.

FIG. 10A is a user interface diagram illustrating an example emergency override feature.

FIG. 10B is a user interface diagram illustrating an example third-party override feature.

FIG. 11 is a flowchart diagram illustrating an example process managed by the device management system to maintain synchronization among multiple electronic devices for a user to complete one learning process before receiving a reward.

FIG. 12 is a flowchart diagram illustrating an example process performed by a client of the device management system for synchronization with other electronic devices for a user to complete one learning process before receiving a reward.

FIG. 13 is a flowchart diagram illustrating a process performed by the device management system to coordinate multiple devices owned by multiple users in reward-based learning experiences.

FIG. 14 contains a block diagram illustrating an example architecture of a computer, which may represent any electronic device, any server, or any node within a cloud service as described herein.

### DETAILED DESCRIPTION

As used herein, the term “User” refers to the person (e.g., student) who is attempting to gain access to their electronic computing device, such as a cellular phone, tablet, laptop, personal computer, wearable device, television, and game console, or other reward, and may be required to complete one or more assessment tests or complete historical analysis interviews to determine their optimal learning conditions.

As used herein, the term “Third Party” refers to the entity that plays a supervising role in a user's learning experiences. For example, a third party may be a parent, an employer, a coach, etc.

As used herein, the term “Software” refers to computer program instructions adapted for execution by a hardware element, such as a processor, wherein the instructions comprise commands that when executed cause the processor to perform a corresponding set of commands. The software may be written or coded using a programming language, and stored using any type of non-transitory computer-readable media or machine-readable media well known in the art. Examples of software in the present invention comprise any software components, programs, applications, computer programs, application programs, system programs, machine programs, and operating system software. For purposes of this invention, instructional material and instructional software is the same as education material and education software insofar as an instruction can be to complete a question, among other actions, like move an arm or run a specific distance.

As used herein, the term “Module” refers to a portion of a computer program, software or computer hardware that carries out a specific function (e.g., testing module, etc.) and may be used alone or combined with other modules of the same program.

With the explosion of electronic devices, especially smart mobile devices, a parent, by using such programs as Smart Controls by AT&T, Inc., might restrict the SMS (text message) function of a mobile phone by blocking the use of such an application through the network provider during specific periods of time. However, a mobile phone that has had the SMS function blocked by the network provider can still be connected to the Internet (by using an alternative Bluetooth® or local Wi-Fi connection or “hot spot” through a smart phone for example) providing the child with the ability to download one of several alternative services (or mobile applications) that enable SMS, such as the SMS service on AOL, Inc. In other words, the parent could contract with the network provider of the phone service to block the SMS function during school hours. However, if the child has an Internet or cellular connection on their electronic computing device, s/he can still SMS by accessing another feature offered through the Internet or wireless community.

Manufacturers of electronic computing devices such as laptop and desktop personal computers, smartphones, cell phones, smart televisions, gaming devices, and tablets already provide a security access process system. In some cases, options of security control strategies are available, such as slide lock, security number, security letters, combinations, etc. However, most of these strategies are intended to ensure that someone other than the targeted user of the electronic device is denied access, limited by periods of time or screened or filtered. Standard “parental controls” are offered as a standard feature to most on-line services from Wi-Fi to cable or satellite televisions. These standard parental controls have a number of limitations, such as they don't communicate to individual devices. For example, a parent could use a setting to block the use of time for, say, school hours of 8:00 AM to 3:00 PM each week day on the smart phone, but that does not enable the smart phone to synchronize or communicate with other electronic computing devices such as the smart television, the laptop or the game console. In most cases, the parent is forced to create a custom parental control for each individual electronic device to prevent the child from simply moving from one smart device to another to find the device with the lowest level of security access or parental controls.

Various embodiments disclosed in this application provide a security system designed to block and limit the use of different features/functions on an electronic computing device (or a suite of electronic devices) by the target user (e.g., child), until s/he accomplishes specific education-based objectives as controlled by a third party, such as a parent, teacher or employer. The user must successfully complete education modules to unlock the device, and then complete additional modules to be able to gain access to various programs and/or functions on the device for specific periods of time.

FIG. 1 is a diagram illustrating an example environment in which a device management system 140 manages access of electronic devices individually or in synchronization. The device management system 140 links together a reward system 150 and a learning and education system 170 to motivate and enhance the learning experience of users through the use of electronic computing devices and other means.

In some embodiments, the device management system 140 comprises a client-server architecture where the server portion stands alone or runs on a cloud-computing platform, and clients communicate with servers via networks.

The device management system 140 or the server portion thereof may reside on the cloud-computing platform 130, making its functions readily accessible by other systems that are connected to the cloud-computing platform 130, which may include the user device 100, the monitor device 120, the network service provider system 160, the learning and education system 170, and the reward system 150.

In some embodiments, the device management system 140 is entirely integrated into a system or a device, such as a user's electronic computing device or a network service provider system. In addition, the system may be integrated into or in communication with the reward system 150 and the learning and education system 170.

In some embodiments, the device management system 140, or at least the server portion, may stand alone and communicate with network service provider system 160, the learning and education system 170, and the reward system 150 through their application program interfaces (APIs), to simplify change and maintenance, for example. In addition, the device management system 140, the server portion, or the client portion may be integrated into some of these other systems to reduce network traffic, for example.

The network service provider system 160 comprise commercial entities providing services to wireless and digital electronic computing devices, such as Vodaphone Group Plc, AT&T Inc., Verizon Communications Inc., etc. They may control the network connectivity and data usage of electronic computing devices, and their products and services may incorporate the reward-based learning system 150. For example, when a parent signs up for a wireless plan, he may specify performance objectives, skills to be improved, and rewards to be earned for his child as part of a service agreement, and the wireless company as a network service provider system 160 may utilize the reward-based learning system 150 to communicate with learning and education systems 170 and reward systems 150, for example, and streamline the learning-reward process for the child. In alternative instances using smart televisions the network provider may be a cable company or a satellite company. Further the network delivery could include a “smart” box that routes digital information to multiple smart devices including the smart television.

The learning and education system 170 comprises systems and methods for evaluating performance statistics, providing testing and education materials, analyzing learning patterns, and so on. In terms of providing testing materials, the learning and education system 170 may maintain various formats—test questions taken before a reward is given—as well as goals or other evaluations. The testing subject matter (e.g., math, history, missed test questions, etc.) and format (e.g., multiple choice, true/false, pattern recognition, etc.) may be selected by the user, the monitor, and so on. As one example, on a particular day, the student chooses the level of difficulty of the questions, the subject matter, etc. depending upon their mood, their time availability, their level of fatigue, a pending deadline (e.g., SAT test date), etc. As another example, the test questions may be chosen by a monitor (e.g., parent or the system) and depend upon: the user's performance on a test or goal administered by another (e.g., SAT grades); a user's performance over a period of time in a particular area (e.g., semester grade in a class) and/or as a whole (e.g., semester grade average for all classes). The test questions and the user's answers may take multiple formats of electronic communication: SMS texting; regular text document on a webpage or downloaded in write-over formats (e.g., Word, write-over PDF, etc.); still images; video; audio; etc.

In addition, the test materials may comprise the user accomplishing more than one task concurrently that are related in topic—such as questions and then a practical exercise. As one example, a test may involve a series of questions about how to safely operate a particular home appliance. As another example, an employer may require new or periodic training for his employees for operating equipment such as a forklift or other machinery. The test taker must answer the questions correctly and operate the appliance safely and correctly before receiving a reward.

In terms of providing education tools, which may be presented to a user before or after the presentation of test materials, the learning and education system 170 may compile materials on various topics, from subjects taught and tested in school, such as English and history, to those of general interest, such as journalism and entertainment. It may further classify these materials into different difficulty levels and formats. For each user, the selection of difficulty level and format may depend on the user's performance statistics, learning styles, etc. For example, for a student in the history class who has received a high score, the education materials may cover advanced subject matter with complex details, while for a student who has shown no interest in history, the education materials may cover basic topics in an easy-to-absorb format. Educational institutions, specialized learning agencies, and/or supervisors may work together towards the compilation of necessary materials based on first-hand teaching experiences or additional research. In another example of an “adaptive learning” element, the analyses can be applied where as the student answers questions correctly the questions (and or question types) get more challenging. Alternatively, as the student answers questions incorrectly the questions (and or questions types) get less difficult. In addition, the adaptive learning element can include indirect signals (i.e. those not directly related to correct and incorrect answers) from facial patterns and optical tracking. Both of which can be measured by features common to smart devices that are well known to those in the art.

In terms of analyzing learning patterns, the learning and education system 170 may analyze how a user goes through existing learning processes and predicts effective learning processes for the user based on trends and patterns detected in the analysis. As used herein, “pattern recognition learning” refers to the ability to learn new information by a simple examination of new material. An example might be a student who memorizes the multiplication table but does not understand the relationships of the numbers. Specifically, a student might know that 7 times 6 is 42 but they may not understand the relationship of numbers. In addition, “cognitive learning” refers to the ability to learn new information by an analysis and detailed examination of new material. An example might be a student who doesn't memorize the multiplication table but understands the relationships of numbers. Specifically, a student might not know 6 times 7 is 42, but he knows that if you add (7+7+7+7+7+7) or (6+6+6+6+6+6+6) a correct answer will be achieved.

As one example of analysis, the learning and education system 170 may determine if a particular student's learning is enhanced when a new topic is introduced through cognitive skills or pattern recognition skills: whether the format of the new content is visual, audio or interactive; whether a student performs better when answering multiple choice or true-false questions; and whether the student does just as well on the final 10 questions as the first 10 questions. As another example of analysis, the learning and education system 170 may determine a user's frequency in test taking (e.g., date and time) and track the test timing to determine student's optimal performance or poor performance due to specific factors. The learning process is not limited to academic themes and may include physical exercise, rehabilitation, physical education and the like. The activation is not limited to physical connections and may include audio, optical tracking, gestures of the users limbs, movement of the electronic device and the like.

The reward system 150 comprises various forms, such as: the unblocking of a user's desired electronic device, and/or functions on the device (e.g., gaming applications, Internet access, texting, video chat); and/or other activity non-related to the use of electronic computing devices; and/or giving the user in/tangible item(s). The user may select the type of the reward, or it may be automatically designated based on the type of testing or by the supervisor. Other examples of forms of rewards comprise cash, a retailer redemption debit card, and a coupon redeemable online or at a store. Further still, in an employment setting, the employee may be given a monetary bonus, extra holiday or vacation time or discounts on the employer's products and services as a reward.

Various embodiments disclose that the device management system 140 is integrated with the reward system 150 and offers authorizations for access of electronic devices owned by users as rewards for finishing education contents or other learning processes. Access to an electronic computing device may be controlled by different methods/entities, comprising: 1) software modules on electronic computing devices, as discussed in further detail below, which may block the use of the device until academic requirements (e.g., quiz blocking access to SMS) are satisfied; 2) network providers, as discussed in further detail below, who may block access to a user's account/device until certain performance objectives are met; 3) education module providers, as discussed in further detail below, which may block access to a student's device until grades are achieved, and 4) supervisors owning the device utilized by the user—e.g., employer-owned personal digital assistants for employee use.

A number of security options exist to block and unblock electronic transmissions from a computing device in order to, for example, protect the device from being used inappropriately. Methods known by someone skilled in the art comprise those for handling the following scenarios: (1) use by unauthorized person; (2) use at an unsafe time; (3) use to explore “inappropriate” applications; (4) use to abuse “appropriate” applications.

In some embodiments, the cloud-computing platform 130 represents a family of services hosted on one isolated server, multiple isolated servers, or on distributed servers that virtually appear to clients to be a single server. It is isolated or divided onto isolated different servers to facilitate the isolation, organization, and management of diverse families of functions that may be accessed by some authorized parties but not others. As one example, the services that may be utilized by the assessment system 170 may be hosted on one server. As another example, the services for submitting new education and testing materials by the monitor device 120 and the services for dispersing such materials to the user device 100 may be hosted on separate servers. In order to properly function, these separate servers may need to privately share information with each other via messaging and API calls, via common interfacing, and messaging techniques known to those skilled in the art.

A user device 100 is a user's electronic computing device with web browser capabilities configured to communicate with the device management system 140 via the cloud-computing platform 130 or otherwise through networks, which comprises any public network such as the Internet or World Wide Web or any public or private network as may be developed in the future. It is the means by which the user participates in the CIES. It may receive and respond to educational/testing modules provided by the education and learning system 170, reward data provided by the reward system 150, and other modules and data loaded into its memory. The monitor device 120 is a monitor's electronic computing device with web browser capabilities configured to communicate with the user device 100, or with the device management system 140, through the cloud-computing platform 130 or otherwise via networks. The user device 100 and monitor device 120 may connect to the network via a variety of methods such as a phone modem, wireless (cellular, satellite, microwave, infrared, radio, etc.) network, Local Area Network (LAN), Wide Area Network (WAN), or any such means as necessary to communicate to a server computer connected directly or indirectly to the network.

In some embodiments, the user device 100 and the monitor device 120 are one in the same electronic computing device with the client portion of the device management system 140 installed thereon. The client portion enables the monitor to select and/or review the activity of the user in practicing educational modules. The monitor's access to the educational modules may be protected by a security feature (e.g., login credentials) to permit the monitor to select the educational modules for the user to practice and the approved solutions (e.g., answers) for the modules.

In some embodiments, the user device 100 has the client portion or the entirety of the device management system 140 installed to enable the user to practice test/educational modules and/or to enable the user to receive rewards 110 upon a satisfactory practice. As one example, the client portion may have the device blocked with direct control or through a network service provider. Upon a successful completion of the modules, the client portion then permits the blocking of the entire user device 100, and/or particular features (e.g., Internet access or texting capabilities) of the user device 100. As another example, if the user has elected to receive cash and/or deposits to their credit or debit cards from the monitor, the user device 100 may communicate successful completion of the educational module directly with the monitor device 120 or through the device management system 140, which may then notify the monitor device 120 of the reward due. The cash transactions may be accomplished by using PayPal or Amazon Coins, for example.

As a scenario in this example environment, a device, such as a smartphone, may have an unlock application (either a native application or one downloaded through cloud services) which controls access to the device. The unlock app contacts the gateway component which instructs it whether or not the device can currently only be unlocked via correct interaction with educational content, and then displays that content to a user of the device. If the user properly interacts with the content (such as giving a correct answer to a question), the unlock app terminates its function and surrenders control of the device to the user.

The lock/unlock functionality could be programmed directly into the operating system running on the electronic device as a native application, or it could be implemented as an external, standalone application to be installed on the electronic device. The application is activated whenever the electronic device is powered up, restarted, or comes out of sleep mode. (If the electronic device has just entered sleep mode, the application may allow instant access without challenge, if the last time the device was accessed was within a certain period of time.) The application may contact the multi-layer reward module 206 via internet connection enabled by Wi-Fi or Carrier Data Plan, using a URL which resolves thereto. The application may receive a payload of information in a data packet in a common data interchange format such as XML or JSON, which contains educational content and an unlock status code (USC). The USC may instruct the application that the device is (a) un-lockable, (b) freely un-lockable, (c) un-lockable after appropriate interaction with educational content, or (d) other conditional possibilities. If access to the device is conditional {i.e. (c) or (d)}, the application will present a user interface which will prompt the user to correctly interact with it in order to unlock the device. If the interaction is correct, the application terminates after allowing full access to the device's operating system's main user interface for accessing the device's functionality. If the interaction is incorrect, the application will process certain logical conditions which may allow second chances to interact correctly with educational content, optionally after a certain wait period, and/or allow visual and/or auditory access to learning content prior to answering again, and/or give second chances at new content, or completely block access, or other logical possibilities.

In some implementations of the invention, the content and/or conditions of unlocking and/or restrictions and/or conditions and/or rewards given for correct interaction, may be accessed from other third party Internet connected devices or monitor devices, which enables authorized users to specify content, restrictions, rewards, and so on (collectively “establishing the unlocking criteria”).

A parent may use their third party device to make a request to the gateway component through the cloud services for their child to answer a math question such as 4×4. The gateway component then sends requested answer to the child's electronic device through the cloud services. Once the answer is input onto the device by the child, the input is processed from the child's electronic device, and the information is sent back to the gateway component, which will then send the answer back to the third party device, in this case identified as the parent.

FIG. 2 is a block diagram illustrating example components of the device management system 140. The device management system 140 comprises an education module 202, a user module 204, a multi-layer reward module 206 and a multi-device control module 208. In some embodiments, the education module 202 interacts with one or more learning and education systems 170 to supply learning processes to users. It may allow a learning and education system to upload education contents, including questions, answers, media links, audio videos, eBooks, etextbooks, etc. and the like. The upload may be performed using one of a variety of protocols, including FTP and web-services. In addition, the education module 202 may allow a learning and education system to sign up for a location-based feature. In that case, it may enable an education system to directly receive a user's GPS coordinates to determine whether the user is where he is supposed to be, such as a particular class room, or it may track a user's GPS coordinates and forwards the user's location information to the education system. For example, a third party might require that a device user on certain days of the week to (1) show up and check in to a school location by a certain time, (2) check in as still at school at the end of the school day, (3) check in at home by a certain time, (4) check in at home later in the evening to prove the user is still there, as a way of engaging in a learning process. The learning and education system may then customize the learning process to include specific unique learning questions or instructions to confirm that the end user and the end user's device are in the specified coordinates requested by the third party. The questions or instructions are not limited to academic themes and may include physical exercise, rehabilitation, physical education, employment related training and the like.

In some embodiments, the user module 204 manages interactions with a user of an electronic device. The user module 204 may allow a user or a third party to set up an account and register electronic devices owned by the user. The user module 204 may enable a user to perform a learning process. For example, it may display education contents to the user and accept the user's replies to the education contents. It may monitor and report the user's current learning state for a specific subject matter and the progress on the current learning process. It may also inform user of information regarding a reward or any error. When progress of the learning process needs to be centralized and synchronized across multiple devices, including the user's electronic device, the user module 204 also tracks the centralized progress and coordinates activities on the user's electronic device with those on other electronic devices connected to the cloud-computing platform 130.

In some embodiments, the multi-layer reward module 206 allows a user to set up a multi-layered access protocol for an electronic device, such as a cellular phone, a laptop, a gaming station, and so on. According to the multi-layered access protocol, access to the electronic device is controlled in layers. For example, access to features of the electronic device may be in the first layer, access to basic applications on the electronic device may be in the second layer, and access to advanced applications on the electronic device may be in the third layer. Different learning processes would be associated with different layers, completing the learning process associated with one layer leads to access to the electronic device in the corresponding layer, and the learning process associated with the current layer needs to be completed before the learning process associated with the next layer may be initiated.

In some embodiments, the multi-device control module 208 manages the operations of multiple electronic devices, which can belong to the same user or different users. The multi-device control module 208 may allow users to assign to the electronic devices various learning processes that need to be completed before features of and applications on the electronic devices become accessible. These learning processes may be unrelated or they may be in increasing levels of difficulty across the electronic devices. Furthermore, the multi-device control module 208 may control the completion of one learning process across all the electronic devices such the learning process may be completed on any of the electronic devices without repeating previous efforts and the learning process needs to be completed before access to features of and applications on any of the devices is enabled. In addition, the multi-device control module 208 may control the completion of multiple learning processes across all the devices such that each learning process needs to be completed on all the devices before the next learning process may begin on any of the devices.

Operations of the multi-layer reward module 206 are further described below. The instruction to enable multi-level locking on a user's electronic device may come from an administrator, a person supervising the user (e.g., the third-party parent or employer), or a manager of a system server, whom the user and/or their supervisor have granted permission to control the unlocking and functionality of the device via a network, such as a commercial entity providing a fee-based service or a Dynamic Host Configuration Protocol (DHCP). The administrator would contract with the entity directly or with the network service provider of the user's device(s), who subsequently provides this service via the entity or internally as part of the provider's business organization. For example, Mindflash Technologies, Inc. and Knoodle, Inc. offer cloud-based services that enable companies to organize training for employees through a centralized training and testing platform despite employees being located around the world and access the portal with various brands and types of electronic devices.

To implement the system, a third party supervising the user, and/or the user, creates an account with the device management system 140, which generates questions and controls the un/locking of the device(s). Alternatively, the education modules may be stored in the devices' memory. The devices' processor then generates the questions and controls the un/locking of the device.

In addition to requiring the user to complete education-based tasks in order to unlock a device, the multi-layer reward module 206 may also subsequently require the user to complete additional education-based tasks to have partial or complete use of programs, or types of programs installed on the device for, say, specific periods such as 30 minutes and further education-based tasks for extended periods of usage. For example, once the user has successfully answered one or more test questions to unlock the device, in lieu of or in addition to other security features on the device (e.g., a “slide lock”, see infra), then the user may be required to complete another education module in order to access any program that is part of the Microsoft Office software package. And further still the user may be required to complete additional questions periodically to extend his use of the device for his entire working day of 8 hours. This ensures that the employer has provided material to the employee over a consistent period of time as to not distract the employee from the primary daily duties. In yet a further example, the access mechanism can include instructions, as questions can be considered a form of instruction.

The subject matter, or content, of the different education modules used to unlock the different types of programs may be the same or may be different. For example, the content to unlock any program on the Microsoft Office package may relate to one subject, while the content to unlock an email account and/or an Internet browser is to a different subject. Likewise, mobile applications of a similar function, such as games, may all be blocked by requiring the completion of a first education module, while mobile applications related to social networking are blocked by a second education module.

The functionality of each computer program or function on the device may also be linked to the completion of the amount of education modules successfully executed by the user. For example, the completion of one education module may grant the user access to “read” only functionality of a software program, such as Microsoft Word®. The user would then need to complete additional questions within the same education module (e.g., comprising the same content of the same or of increasing levels of difficulty), or complete a different education module (e.g., module comprising different content) before being able to edit the Microsoft Word document. It is similar with mobile applications, such as the game Angry Birds.

Questions generated may be: 1) random; and/or 2) of the same level of difficulty; and/or 3) on increasing levels of difficulty for unlocking each feature on the device. Additionally, the levels of difficulty of the questions may increase on a temporal basis (e.g., day-to-day, week-to-week, etc.). Therefore, the testing modules of the present invention may further comprise a series of questions, such as those related by subject matter (content, e.g., all calculus), and/or building in complexity, that must be successfully executed by the user before s/he is granted access to the device, and/or specific functions/software on the device. In another example, the multiplication tables could start with one's (i.e., 1*1 to 1*12) and build up to twelve's (i.e., 12*1 to 12*12).

The questions generated may also be: 1) specific to the device user; and/or 2) specific to a group of similar users. For example, a group of users may have a common educational requirement, such as all users who are high school students preparing for the SAT examination, or all employees within a division of a company. Alternatively, a group, such as a department within a company or a class within a school, could be responsible for completing a group of questions so when the education module is complete access is permitted for all. In yet another example, an individual or group could be responsible for exercising or transporting themselves over a specified set of travel coordinates.

The user may also have the ability to select the subject matter of the questions in the education module that locks a particular feature of the device. For example, the user may select math questions to access their Internet browser, and grammar questions to access their SMS (texting). The user may indicate their selection by either typing in, touching a touch screen enabled device, or speaking for an audio enabled device at the time of attempting to unlock the features or any other means of motioning for a correct answer, and/or when establishing their account on the system server. By way of example work with a handicapped child or a patient in rehabilitation could nod their head or gesture a part of their body and movement software like Xbox Kinect would be engaged. Alternatively, optical tracking can be used for purposes of directing a particular answer or response to an instruction.

Existing testing software and mobile apps may be incorporated into learning processes for a user, such as to improve a student's SAT scores. They may be downloaded onto the user's electronic device. The multi-layer reward module 206 may be designed to work with the SAT (or the like) testing software to provide SAT (or the like) specific questions and grading of the user's performance by topic or skillset in a manner that improves the user's performance for the real standardized test.

The multi-layer reward module 206 may control access of a user's electronic device as follows. A lock/unlock application on the electronic device may contact the multi-layer reward module 206 through the cloud-computing platform 130, which may instruct the application whether or not the electronic device can currently only be unlocked via correct interaction with educational content. The application may then display that education content to the user. If the user properly interacts with the content (such as giving a correct answer to a question), the unlock app terminates its function and surrenders control of the device to the user.

The lock/unlock functionality could be programmed directly into the operating system running on the electronic device as a native application, or it could be implemented as an external, standalone application to be installed on the electronic device. The application is activated whenever the electronic device is powered up, restarted, or comes out of sleep mode. (If the electronic device has just entered sleep mode, the application may allow instant access without challenge, if the last time the device was accessed was within a certain period of time.) The application may contact the multi-layer reward module 206 via internet connection enabled by Bluetooth®, Wi-Fi or Carrier Data Plan, using a URL which resolves thereto. The application may receive a payload of information in a data packet in a common data interchange format such as XML or JSON, which contains educational content and an unlock status code (USC). The USC may instruct the application that the device is (a) un-lockable, (b) freely un-lockable, (c) un-lockable after appropriate interaction with educational content, or (d) other conditional possibilities. If access to the device is conditional {i.e. (c) or (d)}, the application will present a user interface which will prompt the user to correctly interact with it in order to unlock the device. If the interaction is correct, the application terminates after allowing full access to the device's operating system's main user interface for accessing the device's functionality. If the interaction is incorrect, the application will process certain logical conditions which may allow second chances to interact correctly with educational content, optionally after a certain wait period, and/or allow visual and/or auditory access to learning content prior to answering again, and/or give second chances at new content, or completely block access, or other logical possibilities.

In some implementations of the invention, the content and/or conditions of unlocking and/or restrictions and/or conditions and/or rewards given for correct interaction, may be accessed from other third party Internet connected devices or monitor devices, which enables authorized users to specify content, restrictions, rewards, and so on (collectively “establishing the unlocking criteria”).

In one example, a parent uses their monitor device 120 to make a request to the multi-layer reward module 206 through the cloud-computing platform 130 for their child to answer a series of drivers education questions, in this case the child's electronic device is a “smart” system in a vehicle such as Ford Sync®, the multi-layer reward module 206 then sends requested drivers education questions to the child's electronic device. Once the answer is processed from the “smart” system, the information is sent back to the multi-layer reward module 206, which will then send the answer back to the monitor device, which then tells the parent the answer. If the answer is correct, the multi-layer reward module 206 then allows access. In another example, the parent could request that specific driving conditions such as speed and time at stop signs are monitored. The multi-layer reward module 206 would process information in conjunction with a GPS system embedded in the child's electronic device.

Accessibility to the device can also be granted or restricted based on other criteria. In one implementation, a native or web application presents an option to the user for location-based check-in, which allows the user to indicate via user interface such as a button or slider that s/he is checking in at his/her current location. The native application may use the device's native location services which use GPS and other means such as APIs which report location based on Wi-Fi SSIDs and/or triangulation based on signal strength of cell towers; or the native application or web application may use various means such as web services where location is sourced via IP address. This information is transferred via internet to web service API(s) at server(s) which record this information in database table(s) associated with the user and his/her device. Based on device access rules that have been specified by a third party on same server(s), application logic is triggered on the server that, based on compliance with check-in rules, will restrict or un-restrict locking of the device for certain periods of time.

Restriction or unrestriction of the device, as in other implementations, can be tied to certain periods of time, certain applications, certain functions within an application, and so on as described elsewhere. Likewise, check-in can be a required step and/or an automatic step at various levels of unlocking, such as the device level, the application level, the level of sub-functions within the application, such that access at any of these points requires a check-in and comparison of the rules a third party has given to the device for check-in and access to certain levels and functions within the device.

For example, a third party might require a device user on certain days of the week to (1) show up to a school location and check in by a certain time, (2) check in as still at school at the end of the school day, (3) check in at home by a certain time, (4) check in at home later in the evening to prove the user is still there. Rules can be specified such as all four rules must be met to keep the device usable for the next 48 hours, or that at each check-in, 2 hours of usage are unlocked, or indeed, any number of other rules as described elsewhere.

FIG. 3 is a user interface diagram illustrating examples of deploying the multi-layer reward module 206 on a user's electronic device to effectively disable features of the electronic device until the user completes one or more desired tasks. In particular, the following are an overview of each of the individually numbered features.
The device has a user interface 300 comprised of a display to view operating system 303 output and application 312 output as well as one or more methods to detect user input, including but not limited to hardware control buttons 302 such as a keyboard or function key, a touchscreen 301, a mouse pointer device 314, a camera or optical sensor 315, and/or a game controller device 313.
The device has a software- or firmware-based operating system 303 that allows applications created by third parties to accept input from the user interface and to control output to the display 301.
The operating system 303 exposes one or more application programming interface(s) to allow third party applications 312 to monitor and/or intercept device user interface 300 input, and to control the device hardware through software commands.
The operating system 303 exposes one or more application programming interface(s) to allow third party applications 312 to selectively kill running processes or applications 312.
The operating system 303 has a method of utilizing network connectivity hardware 307 such as a network interface driver 306 to allow the device to connect to a plurality of computer devices on a network, such as the Internet 308.
The device operating system 303 or third party application 312 provides a software firewall 305 that is capable of controlling access to the network by selectively allowing or denying access to the network.
Applications 312 often require access to the Internet 308 and more specifically to internet resources 311 such as a control server 310 that may include application functionality support and a database containing data essential to the functionality of the application 312.
The operating system 303 requires connectivity to a remote DNS (Domain Name Service) server 309 in order to support application 312 access to control servers 310 and Internet resources 311.
The operating system 303 maintains network connectivity settings, including an internet protocol address for the device's network hardware 307 as well as remote service addresses including the IP address of one or more DNS (Domain Name Service) servers, as required to provide name resolution for accessing a control server 310 and other Internet resources 311 such as a website or web service.
The operating system 303 supports applications 312 such as locking software 304, as part of the multi-layer reward module 206, starting each time the operating system 303 is initialized.

Using FIG. 3 and the definitional references provided as a background, the locking software 304, could provide one or more layered lock methods, (such as those described in FIG. 7, FIG. 8 and FIG. 9) to ensure that users utilize the device in a particular way. Those lock methods include, but are not limited to:
1. Instruct the locking software 304 to present display 301 output that occupies the entire display, and intercepts all user interface 300 inputs to selectively disregard any input that would cause the locking software 304 to stop or close.
2. Instruct the locking software 304 to modify the software firewall 305 rules such that access to the Internet 308 is selectively disabled.
3. Instruct the locking software 304 to command the operating system 303 to use a software proxy 317 to inject locking software content in the response data from internet resources 311.
4. Instruct the locking software 304 to command the operating system 303 to disable the network hardware 307 so that connection to the network or internet is disabled (airplane mode).
5. Instruct the locking software 304 to command the operating system 303 to use a DNS server 309 that is interfaced or associated with the locking software control server, effectively redirecting all remote internet resources 311 requests back to the control server 310 for selective processing.
6. Instruct the locking software 304 to command the operating system 303 to use a proxy server 316 that is interfaced or associated with the locking software control server, effectively filtering all remote internet resources 311 responses for content replacement or injection.
7. Instruct the locking software 304 to command the operating system 303 to kill any running process that is not explicitly allowed by the locking software or required by the operating system.
8. Instruct the locking software 304 to command the operating system to disable network hardware 307.

Once the device has been locked (preventing the user from using the device freely), the user can be required to perform specific tasks in order to regain access to third party applications 312, operating system features 303, and internet resources 311.

In some embodiments, the combinations of locking software mechanisms can be used alone to remotely lock a smart device without having a direct link to education content or a reward system. The use of a combination of locking software mechanisms is an important feature to creating a block on the targeted electronic device that cannot be easily circumvented by the targeted end user of the smart device and can be controlled remotely by a third party. For example, in one instance a parent may want to lock his child's phone for a specific period of time whereas in another instance an employee may want to lock his employee's access to a social media but no other devices. This aspect of the invention is not limited to these examples as these are intended to act only as a reference.

The multi-layer reward module 206 may integrate other security features of electronic computing devices, such as “slide-to-unlock” protected devices and password protected devices. For example, U.S. Pat. No. 7,657,849 entitled “Unlocking a device by performing gestures on an unlock image” discloses a method of unlocking an electronic computing device by touching the device screen in a preset manner, such as sliding an unlock image to a predefined location on the screen and/or moving the unlock image along a predefined path. Alternatively, the “slide-to-unlock” feature could also be used as a layer in the multi-layer locking scheme. Similarly, the traditional “lock screen” apps or feature could provide a similar benefit and could be used in combination or each on their own relative to “slide-to-unlock”. One familiar with the art of mobile screen security would understand the nature of the possibilities, as these are just two examples of multiple options. Or, for devices with Microsoft Operating Systems, the present invention can be linked with the “Parental Controls” feature that allows parents to set limits on the hours that their children can use the computer, the types of games they can play, and the programs they can run. Even when the user overcomes the locking means of these other mechanisms, they are still denied access to their electronic computing devices, or particular features on the device, by the present invention. For example, when the child attempts to access a blocked program or access the device after unlocking the slide mechanism on their tablet, a notification is displayed on the screen that a particular program or the entire electronic computing device has been blocked. The child can click a link in the notification to request permission for access to the program or device, and be re-directed to the testing modules of the present invention. Only by correctly answering the questions, will the device be unlocked for the child to access the feature (e.g., Internet), program (game), or the entire device's functionality.

FIG. 4 is a table diagram illustrating a multi-layered access protocol for an employee's electronic device instituted by an employer compared with a lack of access protocol for the employee's electronic device. The electronic computing device is a laptop or desktop computer with Microsoft Office Suite, comprising Word and Excel software programs, and the user is an employee. As illustrated in the table, under the system of the present invention, the employee powers on their computer, and enters their password. They must then answer question(s) to gain access to the “desktop” screen, such as in this exemplification, those related to their work industry or profession (Layer 1). When they subsequently attempt to open Microsoft Word or Excel, they must answer additional question(s) posted on their computer screen, such as ones pertaining to their company's policy on harassment and discrimination (Layer 2). At this point, they only have limited use of the software, such as the “read” only mode. In order to gain access to all functions in the software, they must answer yet another question(s) (Layer 3). Furthermore, if their computer goes into screen saver mode, they are required to answer yet another question(s), and likewise if they wish to use the company email server. The above example would include the standard security password offered through the operating system of the original equipment provider to ensure that the device and the associated learning module are customized to the individual person using the device and not just the device.

FIG. 5 is a table diagram illustrating a multi-layered access protocol for a user's electronic device instituted by a supervisor compared with a lack of access protocol for user's electronic device. The user powers on the cell phone, after which they must answer questions related to, for example, a passage as part of a reading comprehension test (Layer 1). Then, in order to open the text messaging feature on the phone so that they may read their messages, they must answer more questions related to, for example, the content of a video stream from YouTube (Layer 2). And if they want to compose and send SMS messages, then they need to answer yet more questions on their device, such as SAT prep questions (Layer 3). Additionally, if their phone enters idle, or screen saver mode, then they must repeat Layers 1-3, or answer yet more questions, such as basic math questions (Layer 4). The above example would include the standard security password offered through the operating system of the original equipment provider to ensure that the device and the associated learning module are customized to the individual person using the device and not just the device.

FIG. 6 is a user interface diagram illustrating a multi-layered access of a user's electronic device. In this example, the end user is going to power on the electronic device to use the social feed option from a social media application. First, the end user will turn the device on and engage in the normal security settings 610 which are programmed in the operating system. Typically, the security settings request a personal identification code. Next, the end user has to answer the first layer 620 of a specified question(s) prior to getting access to the normal interface 630 of the device's operating system. After answering the question(s), the end user will have access to the normal landing page on the device 630, in which the user would typically see a standard setting such as, but isn't limited to, the time, date, status of messages, etc. The end user next selects the social media application 631 and the device will present the second layer 640 of question(s). After answering the question(s), the user will see the security interface 650 and then enter the security 651 requirements, which are common and used to ensure that only the owner of the content has access to the personal information. At this time, the end user is then directed to the landing page 660. The user chooses the social feed 661 and the device will present the third layer 670 of question(s). After answering the question(s), the user will have access to the social feed 681 from the social feed interface 680. In addition to the first three layers of questions, the device can present a sub-third layer 690 of questions for the user to answer. The sub-third layer 690 could also be used as a “pay as you go” method, rewarding the user with specified amounts of time to use the device. For instance, the “pay as you go” approach may include answering a specific question correctly or following a specific instruction correctly in exchange for earning the right to complete a specific transaction such as posting a picture or writing a blog or posting a “like”. Alternatively, the “pay as you go” may include a unit of time eared for each correctly performed effort. One familiar with the art would know how this process would be completed.

FIG. 7 is a flowchart diagram illustrating an example process managed by the multi-layer reward module 206 to execute a multi-layered access protocol. In step 702, the user and/or the third party, e.g., parent, employer, etc., creates an account with multi-layer reward module 206 via the Internet. In a preferred embodiment, the user creates the account by selecting a login and password. The third party may create their own account in a likewise manner wherein the two accounts would be linked in the records on the system database. The user also links one or more of their devices such as phone, table, personal computer, game console, smart TV and smart car to their account using methods well known in the art of controlling electronic devices remotely. For example, the user may be required to input their device's SIM card identification number.

In step 704, the multi-layer reward module 206 prepares questions for the user. In one embodiment, the questions are displayed on the screen of the electronic computing device that the user is attempting to unblock. In another embodiment, the questions are displayed on one of multiple devices that the user is trying to unblock.

In step 706, the user correctly answers one or more questions displayed to unlock the first layer of security of the device. The user may also be required to correctly execute other security features, such as “slide to unlock” or password entries, to unlock the device which could precede the first layer of security device to ensure the targeted learner is using the device. For example, in cases of multiple members in a family who share a device the system will need to have an individual user password.

In the case of community questions, a module of 30 questions may be provided which are open to a whole group. In other words, each of say 3 students or employees could work together to determine which questions are most appropriate for each. The appropriateness could be based on preferences and proficiencies (such as question type and education material) or they could be systematically assigned. Thus, in one embodiment each of 3 students or employees would answer 10 questions. In the other case, one student could answer all of the questions. The result is the same; the whole group is provided access.

At this point the user will see the normal desktop images, but when they double-click on icons representing features of the device, such as the Internet browser, another education module will appear on the screen. In step 708, the user must correctly execute the second education module in order to unlock a second layer of security of the device. In one instance, the user would be directed to a portal to answer questions until the result is achieved. Just like the APK earning time on the device, this method would allow the user to earn access to internet resources.

In step 710, the user now has the ability to utilize the device's features to a limited extent. For example, they may have the ability to freely roam the Internet until they navigate to restricted websites, such as social networking sites. At the restricted website, they must correctly execute another education module in order to be able to login to the social network site. Alternatively, learning modules may surface for additional time to remain on the particular site. In other words, a question every five minutes to maintain access could be used.

The user must repeat steps 708 and 710 to access all of the functionality for each feature on the device that is controlled by the multi-layer reward module 206. For example, if they wish to utilize any of the programs within the Microsoft Office Suite, that comprises Word, PowerPoint, Excel, Outlook, the user would have to successfully complete an education module to have the ability to only “read” documents/emails (step 708). They would then have to successfully complete another education module to have the ability to “write, edit, save, and electronically transmit” documents/emails. (Same note as above with regards to what an operating system will allow a third party application to limit features of third party applications so specifically).

Additionally or alternatively, the user must repeat steps 708 and 710 to access all of the functionality for each computer program within a software package. For example, the user would have to complete an education module to have the ability to use Microsoft Word®, and another module to use Outlook. In some instances, this could be achieved by way of NTLM security settings at the OS level.

For each education module executed for each layer of security, the questions presented by the system may be randomly generated, or sequentially selected as part of a graduated learning program. And, the questions may be of similar or dis-similar subject matter as selected by the system, the user, or the third party. The user then enters their answer to the question via keystroke input, touch contact on the device screen, or audio input as appropriate to the device's functionality. The multi-layer reward module 206 may then determine if the answer is correct. If it is not, the user is denied access and a message appears informing them of such. The user may also be permitted to retry, such as to retry up to 3 times, to answer the question. The next attempt by the user may be for the same question, or a similar question in content and complexity. If after the set number of allowed attempts the user is still not able to correctly answer the question (or questions if s/he selected groups of questions, then s/he is denied access to the device or a feature or a layer of functionality of a program for a set period of time (e.g., minutes, hours, days, etc.) or indefinitely. And a report of the failed attempts is sent to a third party's electronic communications account (e.g., SMS text message, email, instant message, etc.). The permitted time between attempts may be set by the multi-layer reward module 206, an administrator, or a third party.

After the user completes testing for a session, whether s/he has gained access to the all of the features on their device, the multi-layer reward module 206 will analyze the user's performance to identify trends, strengths, weaknesses, etc., in the user's testing abilities (step 712). Additionally, or alternatively, the analysis may be conducted on a periodic basis as set by the multi-layer reward module 206, an administrator, or a third party. For example, the analysis may be executed every week, bi-weekly, monthly, etc. It may also be altered as needed. For example, for the few months preceding a standardized test, such as the SAT, ACT, GMAT, etc., the analysis may be set to occur daily while the test questions are geared to be similar to those on the test. This constant analysis provides ready feedback to the user to assist them in identifying their areas of weakness on the upcoming test, and motivation to work to improve those areas.

In another example of an “adaptive learning” element the analyses can be applied where as the student answers questions correctly the questions (and or question types) get more challenging. Alternatively, as the student answers questions incorrectly the questions (and or questions types) get less difficult. In addition, the adaptive learning element can include indirect signals (i.e. those not directly related to correct and incorrect answers) from facial patterns and optical tracking. Both of which can be measured by features common to smart devices that are well known to those in the art. The learning process is not limited to academic themes and may include physical exercise, rehabilitation, physical education and the like. Furthermore, the “adaptive learning” can incorporate additional features such as those described elsewhere in this document pertaining to facial recognition and optical scan analyses. In these instances the electronic computing device used by the end user serves an additional purpose by measuring bio-physical aspects of the end user to enhance their learning experience. In other words, some end users may form disgruntled looks on their faces or roll their eyes when they are frustrated with the learning objective. It is an intent of this invention, among other things, to intercept the learning experience before the end user answers a question incorrectly by changing the value of reward (and thereby increasing motivation) or by decreasing level of difficulty. The same bio-physical observations can be made with reward selection and assignment and therefore the same interception strategy can be followed. Bio-physical observations include sound level detection, heart-rate, blood pressure, sleeping pattern, etc.

Lastly, the Application will generate a progress report on the user's performance, and transmit the report electronically via a network to the third party, and/or administrator (e.g., employer) (step 714). The report may be electronically sent every time the user has participated in a test session, or on a periodic basis, as per the application analysis of the user's performance. The report may comprise a variety of types of information on the user and statistical analysis or other computations, comprising: layer of unblocking achieved on one or more of the user's devices; number of attempts to gain access to a device within a set time period; success or failure at attempts; trends in performance, strengths, weaknesses, etc., and/or the actual questions and answers on the test, percent improvement from previous test or over a period of time, and so forth. The content of the report may be determined by the multi-layer reward module 206, an administrator, or a third party.

FIG. 8 is a flowchart diagram illustrating another process managed by the multi-layer reward module 206 to execute a multi-layered access protocol. In step 802, the user and/or the third party, e.g., parent, employer, etc., creates an account via an electronic computer device by a download of a client portion of the device management 140 from the Internet. For example, a native app could be installed from an Android application package (APK) file, which is the file format used to distribute and install application software and middle ware onto Google's Android operating system. In a preferred embodiment, the user creates the account in the app via the smart phone by selecting a login and password. The third party may create their own account via the smart phone in a likewise manner, wherein the two accounts would be linked. The user also links one or more of their devices to their account using methods well known in the art of controlling electronic devices remotely. Other devices include Tablet, laptop, desktop computer, game console, and smartTV. For example, the user may be required to input their device's SIM card identification number.

In step 804, questions are pulled from memory of the smartphone or dynamically produced using a pseudo-random number generator by methods programmed within the application's logic code. In one embodiment, math questions can be generated dynamically, and the application's coded function can determine the correct answer programmatically prior to accepting the input from the user. In another embodiment, the questions are displayed on the screen of the electronic computing device that the user is attempting to unblock. In another embodiment, the questions are displayed on one of multiple devices that the user is trying to unblock such as Tablet, laptop computer, desktop computer, game console, and smartTV.

In step 806, the user correctly answers one or more questions displayed to unlock the first layer of security of the device. This is accomplished through traditional touching of the electronic devices screen but can also include gestures of the users limbs, movement of the electronic device and the like are also included as mechanisms to record correct answers. The user may also be required to correctly execute other security features, such as “slide to unlock” or password entries, to unlock the smartphone (or other electronic devices) or other common private security settings made available through the devices normal options generally included under “security settings”. For example, with a standard iPhone operating system (iOS), one simply goes to the “settings” widget and then to “general” to “passcode”. In the event the user wants to expand the security code beyond a numeric four digit, they could then select “simple” and will have a combination of numbers and letter characters available for his password.

At this point the user will see the normal desktop images, but when they double-click on icons representing features of the device, such as Angry Birds, another education module will appear on the screen. In step 808, the user must correctly execute the second education module in order to unlock a second layer of security of the smartphone.

In step 810, the user now has the ability to utilize the device's features to a limited extent. For example, they may have the ability to freely play Angry Birds for a prescribed period of time as determined by the nature or the quantity of the questions as established by the third party. At such time as a prescribed period of usage is completed, they must correctly execute another education module in order to maintain playing.

The user must repeat steps 808 and 810 to access all of the functionality for each feature on the device that is controlled by the Multi-Layered Education Lock software on the smartphone. For example, if they wish to utilize any of the other programs on the smart phone such as Facebook® and Instagram®, the user would have to successfully complete an education module to have the ability to only “read” pictures/messages (step 840). They would then have to successfully complete another education module to have the ability to “write, edit, save, and electronically transmit” responses to pictures/messages or even their own pictures.

Additionally or alternatively, the user must repeat steps 808 and 810 to access all of the functionality for each program on the smartphone as determined by the third party administrator. For example, one program such as the daily calendar may not require any further questions after level one whereas another program such as Foursquare may require only questions through level two.

At step 812, the multi-layer reward module 206 analyzes the test results and looks for patterns such as strengths and weaknesses in terms of question format and content difficulty. At step 814, it then transmits a summary of the analyses to a third party and/or the end user. One familiar with the art could configure the analyses and summary in a range of formats.

In another instance of analytical mechanisms and optical tracking software such as the programs created by Tobii Technology, Inc. can provide further enhancements. The optical tracking software can be incorporated into the analytical process by which a learner is engaged in the series of questions or instructions. For example, an important analytical component could include the amount of time that the user's eyes were focused on particular questions and answers. When compared to the time to answer the question, the tracking of the eye over the questions or instructions would provide valuable analytical information to those familiar with the art of teaching and learning including adaptive learning. In another example of an “adaptive learning” element, the analyses can be applied where as the student answers questions correctly the questions (and or question types) get more challenging. Alternatively, as the student answers questions incorrectly the questions (and or questions types) get less difficult. In addition, the adaptive learning element can include indirect signals (i.e. those not directly related to correct and incorrect answers) from facial patterns and optical tracking. Both of which can be measured by features common to smart devices that are well known to those in the art.

FIG. 9 is a flowchart diagram illustrating another process performed by the multi-layer reward module 206 to execute a multi-layered access protocol. In step 902, the user and/or the third party, e.g., parent, employer, etc., creates an account via a tablet by a download of a client portion of the device management 140 from the Internet. In a preferred embodiment, the user creates the account by selecting a login and a password. For example, a native app could be installed utilizing an Android application package file (APK) which is the file format used to distribute and install application software and middle ware onto Google's Android operating system onto the tablet. In a preferred embodiment, the user creates the account via the tablet by selecting a login and password. The third party may create their own account on the tablet in a likewise manner wherein, the two accounts would be linked. The user also links one or more of their devices to their account using methods well known in the art of controlling electronic devices remotely. Other devices include laptop, desktop computer, game console, and smartTV. For example, the user may be required to input their device's SIM card identification number.

In step 904, questions are pulled from the non-volatile memory of the tablet used by the application. In one embodiment, the questions are displayed on the screen of the electronic computing device that the user is attempting to unblock. In another embodiment, the questions are displayed on one of multiple devices that the user is trying to unblock such as a Tablet, laptop computer, desktop computer, game console, and smartTV.

In step 906, the user correctly answers one or more questions displayed to unlock the first layer of security of the device. The user may also be required to correctly execute other security features, such as “slide to unlock” or password entries, to unlock the smartphone (or other electronic devices) through the “settings” widget and following the prompts.

At this point, the user will see the Tablet images, but when they double-click on icons representing features of the device, such as Instagram, another education module will appear on the screen. In step 908, the user must correctly execute the second education module in order to unlock a second layer of security of the Table and receive a prescribed amount of time such as 30 minutes.

In step 910, the user continues his ability to utilize the device's features to beyond the 30 minutes earned in layer 2. At such time, as a prescribed period of usage is completed, they must correctly execute another education module in order to maintain playing. In one case, the education module can be delivered in a “play as you go” format where, for example, one correct answer to a question results in one SMS sent or one picture downloaded. Whereas, in another example, a series of 10 correct answers to questions could result in 10 consecutive minutes of access. In yet another example, any questions incorrectly answered in layers 1 or 2 could be reintroduced. In some cases, the failure to answer a question asked for the second time could lead to an immediate suspension of use of the table for a period such as one minute. Alternatively, an incorrect answer could lead to a deduction of time earned.

The user must repeat steps 908 and 910 to access all of the functionality for each feature on the device that is controlled by the Multi-Layered Education Lock software on the Tablet. For example, if they wish to utilize any of the other programs on the Tablet such as Facebook®, Angry Birds®, the user would have to successfully complete an education module to have the ability to only “read” pictures/messages. They would then have to successfully complete another education module to have the ability to “write, edit, save, and electronically transmit” responses to pictures/messages in the case of Facebook or to play in the case of Angry Birds.

Additionally or alternatively, the user must repeat steps 908 and 910 to access all of the functionality for each program on the Tablet as determined by the third party administrator. For example, one program such as the calculator may not require any further questions after level one whereas another program such as Foursquare may require only questions through level two. As a further embodiment, each of the individual 3 layers of questions could be reset, if the target device leaves a specific set of Global Positioning Coordinates. For example, if a child were to leave the coordinates of his home or the neighborhood in which his home dwells during say a weekend, any one of the three layers of questions could be introduced. Alternatively, the number of the questions could be increased and/or the level of difficulty of the questions could be intensified by the violation of the GPS coordinates. Further still, a correlation of the number of questions and question difficulty could be made as the device is taken further from the target GPS coordinates. For example, each distance of 400 meters from the center of GPS coordinates could lead to a new phase of more challenging and more frequent questions.

At step 912, the multi-layer reward module 206 analyzes the test results and looks for patterns such as strengths and weaknesses in terms of question format and content difficulty. At step 914, it then transmits a summary of the analyses to a third party and/or the end user. One familiar with the art could configure the analyses and summary in a range of formats. In another example of an “adaptive learning” element, the analyses can be applied where as the student answers questions correctly the questions (and or question types) get more challenging. Alternatively, as the student answers questions incorrectly the questions (and or questions types) get less difficult. In addition, the adaptive learning element can include indirect signals (i.e. those not directly related to correct and incorrect answers) from facial patterns and optical tracking. Both of which can be measured by features common to smart devices that are well known to those in the art.

In another instance of analytical mechanisms and optical tracking software, such as the programs created by Tobii Technology, Inc., can provide further enhancements. The optical tracking software can be incorporated into the analytical process by which a learner is engaged in the series of questions or instructions. For example, an important analytical component could include the amount of time that the user's eyes were focused on particular questions and answers. When compared to time to answer the question the tracking of the eye over the questions and instructions would provide valuable analytical information to those familiar with the art of teaching and learning and including adaptive learning. This information would provide an important feature such as reading speed and the reading speed could be analyzed across a variety of question types and even syllable count to track reading even if the problem was related to a multiple choice question among other question types. Further, to the embodiment of this invention the reading section of question set could be separately prepared such that time could be recorded for the reading of the passage compared to the reading of the questions. In other words, does the student's reading speed change when reading background information compared to questions and answer options. Further, still, how many times does the student refer back to the reading passage? Perhaps for instance the student starts with the question and then just scans the reading passage. These patterns and more can be easily determined by those familiar with the related art.

FIGS. 10A and 10B are diagrams illustrating an instant override feature. In each case, the override provides for bypass of the learning modules so that the device can be used for emergency contacts or the device can be used by a third party in such a manner that the user is not forced to respond to the education content. FIG. 10A is an user interface diagram illustrating an example emergency override feature that can be requested by pressing the button 1010 on the user's electronic computing device, for example, but those well-versed in the art will understand multiple alternatives are available. The emergency override feature may be downloaded as an external application 1002 or incorporated into the operating system 1004. The emergency feature allows the end user to select two options. Option one is the emergency services that may be requested by pressing the button 1010a, for example, which connects the user to the local authorities such as fire or police or 911. Option two is the emergency contacts feature that may be requested by pressing the button 1010b, for example, which allows the user to select and contact a predetermined emergency contact list such as parents and friends. This emergency override system connects to emergency services that are offered by the various network providers for smart phones, such as AT&T Inc., on a standard basis.

FIG. 10B is a user interface diagram illustrating an example third-party override feature that may be requested by pressing the button 1012 on the device, for example, but those well-versed in the art will understand multiple alternatives are available. The third-party override feature may similarly be downloaded as an external application 1002 or incorporated into the operating system 1004. The third-party override feature allows a third-party user to enter a custom four digit passcode via the field 1030a and submit the pass code via the field 1030b, which unlocks the user's electronic computing device to its normal functionality. For instance, a parent may share a mobile phone with a child and want to use the phone without answering questions to unlock the mobile phone. The parent would select the third-party override feature, enter the known four digit passcode, and then submit the answer.

Operations of the multi-device synchronization module 208 are further described below. In addition to the system server controlling the unlocking of various functions on a user's device and levels of access to a particular function/program (e.g., “read only”, “edit”, etc.), the server may control unlocking of functions on multiple devices owned by the same user. The education module of each device may also have its own subject matter, designated by the system, and/or user. For example, the user may select at the time of creating their account on the system server to have: a math module controlling access to their smartphone; an English module controlling access to their laptop; a physics module controlling access to their Xbox; and a SAT module controlling access to their smart television.

In yet another example, the locking mechanism could be triggered by using retail based coordinates such as those used by Groupon®, Facebook® and Nearby®, such that any combination of GPS restrictions are placed on a child by a parent. For example, if a child elected to go to a loud restaurant rather than a quiet coffee shop the parent could alter the accessibility of the electronic device from a complete block to partial based on varying types of questions or instructions.

In some embodiments, the multi-device control module 208 allows a user or a supervisor to assign learning processes of varying degrees of difficulty to different electronic devices. One assignment may be to assign a more difficult test to an electronic device that is associated with a higher degree of addiction. Therefore, the user's account could be setup to unlock each device based on the number and/or level of difficulty of questions the user correctly answers. For example, the user may submit to an education based SAT module from their laptop computer that requires them to correctly answer basic SAT questions to unlock the laptop (level 1) and the Internet access on the laptop (level 2). The user then visits the administrator's website, logs into their account, and completes a series of SAT based questions that are of increasing difficulty, e.g., level 3-5. With the successful completion of each level, the user is able to sequentially gain access to each of their electronic computing devices: smartphone (level 3), Xbox (level 4), television (level 5), etc. Alternatively, when the user feels like a challenge or is anxious to watch television, for example, the user may tackle the most difficult SAT questions directly.

Synchronization of multiple devices owned by a user is a relevant consideration because it is common for children to have access to multiple user devices 100 such as their own smartphone, a shared laptop, a shared smartTV, etc. For example, the parent uses their third party device 120 to make a request to the multi-device control module 208 through the cloud-computing platform 130 for their child to answer 5 math questions through any individual or combination of electronic devices. The request is then transmitted to the child's electronic device 100. Once the request is fulfilled and processed from the child's electronic device 100, the information is sent back to the to the multi-device control module 208 through the cloud-computing platform 130. The multi-device control module 208 will then send the user's answers back to the third party device 120 to confirm the request has been fulfilled, in this case identified as the parent. The multi-device control module 208 will synchronize all of the selected user electronic devices through the cloud-computing platform 130 in such a way that each device functions as if it were the same as it relates to answering the command it was given.

In another embodiment of the invention, the synchronization of locking multiple devices can be used alone to remotely lock a group of smart devices without having a direct link to education content or a reward system. The synchronization of locking multiple software mechanisms is an important feature to creating a block on the targeted electronic devices (i.e., smart devices) that cannot be easily circumvented by the targeted end user (or groups of end users) of the smart devices and can be controlled remotely by a third party. For example, in one instance a parent may want to lock his child's access to each of the electronic devices in the child's home while the parent is not also at the home whereas in another instance an employer may want to lock his employees' access to a certain number of his electronic devices but not all (such as locking out of all electronic devices except a tablet).

FIG. 11 is a flowchart diagram illustrating an example process performed by the multi-device control module 208 to maintain synchronization among multiple electronic devices for a user to complete one learning process before receiving a reward. Initially, a user may register a list of electronic devices, such as his cellular phone, tablet, laptop, and so on. Subsequently, the user may start a learning process using one of the electronic devices, on his initiative or as a result of his request for a reward. For example, the learning process could be an English test of 30 questions. The multi-device control module 208 may first set a zero percentage completion status for the learning process. At step 1102, it may then transmit the education content associated with the learning process to each of the electronic device, thereby announcing the user's initiation of the learning process. At step 1104, it may wait for the user to make progress in the learning process. After the user makes some progress on the learning process using one of the electronic devices, at step 1106, the multi-device control module 208 may receive an update from that electronic device indicating the progress made, such as that the first 10 questions on the English test are now completed. It is possible that some of progress is repetitive, when there are delays due to network traffic, for example. For example, 5 of the 10 questions completed on this electronic device might have been previously completely based on the completion status maintained by the multi-device control module 208. The multi-device control module 208 would therefore determine whether the progress reported in the update is indeed progress. At step 1108, it may also determine whether the learning process is fully completed. Upon the determination that the learning process is fully completed, at step 1112, the multi-device control module 208 may forward the update to all the electronic devices, also indicating that a reward is now available to the user. Subsequently, at step 1114, it may receive a request for the reward from one of the electronic devices, and at step 1116, it may forward the reward or any information thereof to the electronic device. Upon the determination that the user has made some progress without fully completing the learning process, at step 1110, the multi-device control module 208 may also forward the update to all the electronic devices, and then go back to the waiting state. The update would enable a user to complete a learning process using any of his electronic devices, generally without duplicating efforts, while preventing the user from receiving a reward using any of the electronic devices until he has completed the learning process.

FIG. 12 is a flowchart diagram illustrating an example process performed by an electronic device serving as the client portion of the multi-device control module 208 in synchronizing with other electronic devices for a user to complete one learning process before receiving a reward. As a user starts a learning process or a task using another electronic device, at step 1202, this electronic device may receive the learning process from the server portion of the multi-device control module 208. At step 1204, it may receive an update from the server portion that a portion of the learning process is now completed. At step 1206, it may allow the user to work on the remainder of the learning process. Therefore, the user may pick up the learning process using this electronic device where he left it off on this other electronic device. It is possible that this electronic device receives the update when the user is working on the portion of the learning process that is reported as completed in the update. In that case, the device may request that the user restart from the beginning of the unfinished portion of the learning process. At certain times, such as periodically or whenever the user finishes a certain amount of the learning process, at step 1208, the electronic device may send an update to the server portion indicating the progress made. At step 1210, the electronic device may receive an update from the server that the learning process is now fully completed and that a reward is available. When the user requests the reward using this electronic device, at step 1212, this electronic device may then forward the request to the server portion.

FIG. 13 is a flowchart diagram illustrating a process performed by the multi-device control module 208 to coordinate multiple devices owned by multiple users in reward-based learning experiences. In step 1302, the multi-device control module 208 allows each user to create an account via the user's electronic computing device. In step 1304, the multi-device control module 208 generates questions, possibly in collaboration with computer network systems used by testing facilitator companies such as Knoodle and Mindflash. In one embodiment, all the questions are displayed on the screen of the electronic computing device that a student or a teacher is attempting to unblock. In another embodiment, the questions are displayed on a sequential basis on each of the three devices that the user is trying to unblock. In another embodiment the number of devices could be two or more than three and any combination of individual devices.

In step 1306, the users correctly answer one or more questions displayed to unlock the first layer of security of their devices. The users may also be required to correctly execute other security features, such as “slide to unlock” or password entries, to unlock the device to identify the respective owners or individuals assigned to the individual devices. For example, using the security functions provided under the “settings” widget.

At this point the users will see the normal electronic display images, but when they double-click on icons representing features of the device, such as the Internet browser, another education module will appear each of the individual screens. In step 1308, the users must correctly execute the second education module in order to unlock a second layer of each of the security of the device. In the case of “community” questions, a module of 30 questions would be provided which would be open to the entire group. In other words, each of the three users, in this example, could work together to determine which answers each user would prefer to answer. The preference could be based on proficiency for specific subject matter (i.e., one is better in math or one is better with true false questions verses multiple choice questions), random generation or sequential assignment. Thus, in one case each user may have 10 questions each or in another case one user could have 30 while the other two have zero. Alternatively, the third-party administrator could be making the assignments so that each user is dependent on the other with targeted questions attacking specific strengths or weaknesses of each user. It could also include a race between the individual users for all or nothing (or portions) of each of the 3 levels.

In yet another embodiment, the teacher could have teams created for each of the individual devices where, for example, each device has a team of several members working as a team. And the competition can be created where the winning members of the team are appointed bonus time.

In step 1310, the users now have the ability to utilize the devices' features to a limited extent. For example, they may have the ability to freely roam the Internet until they navigate to restricted websites, such as social networking sites—Facebook. At the restricted website, they must correctly execute another education module in order to be able to login to the social network site.

The users must repeat steps 1308 and 1310 to access all of the functionality for each feature on the device that is controlled by the Multi-Layered Education Lock software on the system server. For example, if they wish to utilize any of the programs within the Microsoft Office Suite, that comprises Word, PowerPoint, Excel, Outlook, the user would have to successfully complete an education module to have the ability to only “read” documents/emails (step 1340). They would then have to successfully complete another education module to have the ability to “write, edit, save, and electronically transmit” documents/emails.

Additionally or alternatively, the users must repeat steps 1308 and 1310 to access all of the functionality for each computer program within a software package. For example, the user would have to complete an education module to have the ability to use Microsoft Word, and another module to use Outlook. Alternatively, the repeated steps could be applied to a social activity such as Facebook wherein one level of access is reading messages and posts, another level of access is being able to post likes and yet another layer of access would be to post blogs and upload photos as one example of many examples that would be available to one familiar with the relevant art.

Additionally or alternatively, the users must repeat steps 1308 and 1310 to access each of the user's additional electronic computing devices. For example, the users may unlock one of their devices in step 1306, then they would have to successfully execute education modules to unlock their smartphone (step 1308) and then another education module to unlock their tablet (step 1310), and so forth. In some cases, the education content can be lesser. In other embodiments, the education content can be simply by-passed if specific performance standards are met in the initial programs. Processor 1312 analyzes the test results and looks for patterns such as strengths and weaknesses in terms of question format and content difficulty. System (1314) then transmits a summary of the analyses to a third party and/or the end user. One familiar with the art could configure the analyses and summary in a range of formats. In another example of an “adaptive learning” element the analyses can be applied where as the student answers questions correctly the questions (and or question types) get more challenging. Alternatively, as the student answers questions incorrectly the questions (and or questions types) get less difficult. In addition, the adaptive learning element can include indirect signals (i.e. those not directly related to correct and incorrect answers) from facial patterns and optical tracking. Both of which can be measured by features common to smart devices that are well known to those in the art.

In another instance of analytical mechanisms and optical tracking software, such as the programs created by Tobii Technology, Inc., can provide further enhancements. The optical tracking software can be incorporated into the analytical process by which a learner is engaged in the series of questions or instructions. For example, an important analytical component could include the amount of time that the user's eyes were focused on particular questions and answers. When compared to time to answer the question, the tracking of the eye over the questions and instructions would provide valuable analytical information to those familiar with the art of teaching and learning and including adaptive learning.

While a number of combinations to programs and networks are discussed for illustrating the range of locking features in some cases a single program or single network system approach could suffice. Further still, while a number of layers of security access questions or requests for actions are discussed for illustrating the depths and layers of the accessing features and functionality of the electronic device (or family of devices) in some cases a single layer of questions may suffice while in others multiple layers would be incorporated. Further, in some cases, individual components of the device management system 140 may be applicable such as completely locking the targeted user out without providing immediate access to a question or instruction to gain access. In some cases, a delay between the locking relative to the unlocking periods may be desired and could range from seconds to hours or days, depending on the motivations of the third-party.

### Sound Level Control

A voice decibel mechanism that will shut down the software system (or otherwise modify the reward portion or the earning portion if the electronic device detects a sound emitted from the user (or from the smart device itself) at a level higher (as measured in decibels) than a pre-set (or personalized) limit. One familiar with voice decibel systems and the widely available applications to record and detect the decibel level from the electronic device would understand the manner in which the hardware of the electronic device already contains the detection and measurement equipment. In particular, the U.S. patent application Ser. No. 13/568,950 describes many of the features capable of being monitored by the electronic device. This feature disclosed in various embodiments may be particularly useful in a classroom setting where one student might be enjoying a privilege he earned by playing a game while another student is still earning time. In other words, in a classroom setting, when the student is enjoying their reward, he may elect to play a game such as Angry Bird. If the student had the volume too high or was laughing too loud the sound level control would intercept the session. However, any other environmental settings where the sound level is concerned are relevant as well.

Optionally, in one example, the sound level control could simply remove some or all of the time that was earned during session with this invention if a sound level exceeded the established threshold. Further, the sound level control could send out a warning, in the form a dropdown message (like a banner add) before taking an action of shutting down or removing time. In the case of the volume of the device exceeding the established limits the device could adjust itself to the appropriate level or simply eliminate its sound emitting capability for a specific time, or event such as use of a particular application or function. Alternatively, the sound level detected by the electronic device could be used to measure the excitement of the end user engaged in the learning objective. For example, a person excited about completing a module could exert sounds of exhilaration. Conversely, someone frustrated with the learning experience could exert grunts of frustration. One familiar with the art of language and human sound could understand the nature of the differences of the sounds and their implications on learning.

### Special Needs Population

It is also noted that the features discussed in various embodiments of this invention are suitable for use in a variety of situations beyond parent/child and teacher/student, such as by employers training employees, clinicians engaging in rehabilitation of patients who are mentally impaired, etc. For example a child with autism could be provided with educational content on basic hygiene routines, while an adult with Alzheimer's could be provided with education content on family history. The features of this invention may also involve self-monitored learning by an individual who has elected to master a new subject (e.g. foreign language) or exercise their intellect (e.g. memory and analytical exercises for an aging individual). In this scenario, the individual would function as both the system “user” and “third party” by selecting the scope of access denied to the device, such as the entire device or the Internet, or the Facebook® website, etc.; and being provided the analyzed results of their progress directly from the system server.

In another example the electronic device could be used for monitoring the movement via a range of electronic devices such as a smart phone, smart watch or smart glasses. A movement in a targeted motion or position that is part of a learning or training program would be rewarded by providing expanded or full functionality of targeted electronic device(s).

Notwithstanding the examples and references with an emphasis on educational learning, the system and method disclosed in various embodiments of the invention are of particular relevance to other learning applications and conditions or third-party controlled instructions or requests such as, but not limited to, those in medical rehabilitation, hospital patients, special needs children, employee, professional groups (such as accountants, doctors, and lawyers who require annual continued professional credits), specialized training courses, athletic training, physical education, military training, trivia, pre-natal care, emergency response, farming basics, sanitation and infectious disease prevention, domestic violence awareness, and so forth.

As a particular example using a patient reducing brain deterioration with customized mental exercises: A medical-dementia patient elects to use the network as a gateway where for example she informs AT&T Inc. to enable only enable her critical communications including television satellite until after she achieves specific targets on brain exercises. She selects the education venue so that she could identify the precise elements of her brain between cognitive and pattern recognition that were further diminished. These areas then become the priority in her daily exercises. For her reward, she selects retail such as a meal at Denny's restaurant (including senior citizen discount for mental game progress)

### Facial Recognition

In yet another instance of analytical mechanisms, facial recognition software such as programs created to track the “face print” can be incorporated into the analytical process by which a learner is engaged in a series of questions or instructions. For example, a “face print” is a series of various relative positions of various data points on a given face (e.g. nose, eyes, lips, eye brows, etc.) these different data points can be used to determine not only the face print (or the person to whom the face belongs) but the individual data points can also reveal the mood of the face (happy, sad, angry). When compared to the time to answer a question or the level of difficulty (including type of question) the tracking of the facial expression of mood would provide valuate analytical information to those familiar with the art of teaching and learing including adaptive learning. In one of many examples known to those in the level of difficulty to a question could be changed before the student even answered the question. In other words, instead of waiting for the student to submit an incorrect answer before changing the level of difficulty an adaptive program could change the reduce the level of difficulty as the expressions become more frustrated (frown) or increase the level of difficulty as the expressions become more excited (smile or laugh gesture).

### Optical Scan Analysis

Examples of common eye movement patterns include the following: Visual Construction, looking up and to the left. The person is accessing information from theft imagination and might possibly be making it up; Visual Remembering—looking up and to the right. This is when the person is actually accessing a memory and picturing it in his head. Auditory Construction—looking middle and to the left. This is where a person's eyes might go if he was constructing a sound in his mind; Auditory Remembering—looking middle and to the right. This is where a person's eyes might go if he was remembering a sound that he had heard previously; Kinesthetic—looking down and to the left. This is the direction a person's eyes might go if he was accessing his actual feelings about something; and Auditory Digital—looking down and to the right. This is the direction a person's eyes might go when he is talking to himself. All of these provide a new insight that would be a powerful analytical tool to helping and end user better learn or perform the instructions.

Further still, the pupils can be observed and changes in the pupils size (dilation) can provide a new dimension into a student's learning process or an individuals behavior modification. More specifically, the size of the pupils (dilation) can indicate whether the end user is experiencing a higher (larger pupil size) or lower (smaller lower pupil size) challenge based on an optical tracker. This evidence can contribute to the learning material being introduced to the end user so it can be adjusted upward or downward (in difficulty) based on the desired learning platform.

As background, pupil dilation generally correlates with arousal so consistently that researchers use pupil size, or pupillometry, to investigate a wide range of psychological phenomena. Stimulation of the autonomic nervous system's sympathetic branch, known for triggering “fight or flight” responses when the body is under stress, induces pupil dilation. Whereas stimulation of the parasympathetic system, known for “rest and digest” functions, causes constriction. Inhibition of the latter system can therefore also cause dilation.

In one study, a scientist observed that when he instructed subjects to remember and recite a series of seven digits, their pupils grew steadily as the numbers were presented one by one and shrunk steadily as they unloaded the digits from memory. Subsequent research found that the pupils of more intelligent people (as defined by their Scholastic Aptitude Test scores) dilated less in response to cognitive tasks compared with those of lower-scoring participants, indicating more efficient use of brainpower.

### Wearable Smart Devices

Wearable smart devices, in simple terms, are attempts to free data (and other calculating aspects like movement, environmental measurements, calorie consumption, calories burned bio-monitoring, etc.) from desktop computers and portable devices. More specific examples include devices that tracks steps (and stairs) as well as sleep with a vibrating alarm, including an “optimal” wake-up window, that analyzes motion so one can be waken up during the lighter portions of his sleep cycle rather than jarring him awake in the middle of deep sleep.

Many are designed to have Bluetooth®, WiFi and GPS built in. This enables the devices to be used as standalone smart device or in combination with another smart device such as a phone, tablet, etc.

There are different companies that have already emerged with different versions of wearable smart devices and they include Fitbit® offerings, Google Glass®, Samsung Galaxy Gear®, GreenPeak® offerings, InvenSense® offerings, Lumus® offerings, Motorola Solutions® offerings, Nike FuelBand®, Vuzix® offerings and Withings® offerings.

Notable examples of commercial items that one familiar with the art would realize could be interchangeable with the traditional smart devices used such as phone, tablet, game counsel, smart tv, automobile include the products from Fitbit Inc. and Google Inc.

Fitbit Inc. offers several different products that include: Flex™ wireless sleep and activity tracker bracelet that tracks movement, calories consumed, sleeping, etc., Zip™ wireless activity tracker a clip on device that tracks steps, distance, calories burned, stairs climbed and sleep, Aria™ wifi weight scale (a standard home use scale configuration) that tracks weight, body mass index. Each of these devices and all of the information are sent via number of electronic methods where the information is tracked and summarized on the cloud or personal electronic device. Fitbit Inc. also offers an open API so many of the data captures can be shared and included with developments and applications.

Essentially, a Google Glass® is a camera, display, touchpad, battery and microphone built into spectacle frames so that you can perch a display in your field of vision, film, take pictures, search and translate on the go to name a few features. Bluetooth® and Wi-Fi will be built in. A user may user her Google Glass® to interact with the gateway system discussed in various embodiments. The Google Glass and other smart devices may be locked down until targeted learning is completed. They can also provide signals that can be used to support the decision of whether a learning objective was met.

Further, the signals can be used to help contribute to important vital signs of the student or end user and that information can be used to compliment the analytic information that contributes to the “adaptive” learning. Further still, signals from devices like scales can be incorporated into the invention to help an end user learn how to better manage and understand their weight condition. For example, the instruction for an end user could be to weigh himself each morning and record the previous days physical activity and calorie consumption. Until this instruction is followed the target electronic device (or devices), with exception of scale in this case, are locked until the instruction is completed.

### “Smart” Systems for Automobiles

“Smart” car systems such as those offered by Ford Sync® include a range features that can be synchronized. To power Sync, Ford Motor Company partnered with Microsoft Corporation for the software. Microsoft Corporation created Microsoft Auto software, which can interface with just about any current MP3 player or Bluetooth® cell phone. Passengers can connect their cell phones through Sync's integrated Bluetooth® technology. The software will seek the address book and transfer the names and numbers to an internal database. Like many existing Bluetooth® cell phone links, Sync is capable of voice-activated, hands-free calling. Push a button on the steering wheel, and you can speak the name or number you wish to call.

Sync diverts from the traditional Bluetooth® path by utilizing text-to-speech technology to read aloud any text messages you might receive while driving. The system can translate commonly used text message phrases such as “LOL” (laughing out loud). In turn, you can reply to an audible text message from one of 20 predefined responses. Sync® also supports many of the other features found on cell phones, including caller ID, call waiting, conference calling, a caller log, and signal strength and battery charge icons. When you receive a call, Sync can play personal ring tones, including special tones for specific callers. All this information is shown on the radio display screen.

As Sync® primarily runs on software, the system is upgradeable. Ford Motor Company and Microsoft Corporation have plans to allow dealer service technicians to perform updates when the vehicles are in for scheduled maintenance. Updates may also be available on a Web-site for consumers to download and install.

Since the introduction of Sync in the 2008 model year, other car makers have launched similar systems. General Motors Company has expanded its OnStar® service and integrated Sync-like features into its infotainment system, and has even added smartphone apps so drivers can do things like unlock and start their cars remotely. Hyundai Motor Company is launching its Bluelink® service on some 2012 models. Bluelink not only has things like vehicle tracing and crash notifications services, but also includes features like Bluetooth® integration, and location services that allow your car to check in at various locations—something that's helpful if you're a social media fanatic.

### Lottery Style Rewards

The gateway system can include a progressive lottery type of syndicate whereby it is a linked system. In this system a group of students join into a particular type of learning or sign up for a particular type of reward that is provided by a corporate or retail sponsor. For example a group of students studying similar content for a test prep such as the SAT could all compete for a random reward. Specifically, the commonalty is the SAT content and they are each competing for a randomly generated reward. Conversely, a group of employees within a large organization with multiple locations around the world could sign up for a specific reward (such as additional vacation time, a gift certificate for coffee, etc.) regardless of their job training content. Specifically, the commonalty is not the learning content—it is the specific reward.

In another case, the students could wager their accumulated time against each other whereby a single winner (or group of winners) take all or the majority of the collective time. This could be done on an individual, class or school level including any combination of participants. The competition amongst the students could include games one familiar with motivational behavior would know and include those games based on a skill or knowledge, a physical action (like running), a physical change (like gaining or losing weight), luck (like those associated with compulsion) or game of chance or any combination.

### Global Positioning Satellite (GPS) Systems

In the case of tracing GPS coordinates, many smart devices come with a built-in GPS function. The GPS function is a byproduct of using a smart device. For example, the built-in receiver trilaterates your position using data from at least three GPS satellites and the receiver. GPS can determine ones location by performing a calculation based on the intersection point of overlapping spheres determined by the satellites and your phone's GPS receiver. In simple terms, trilateration uses the distance between the satellites and the receiver to create overlapping “spheres” that intersect in a circle. The intersection is your location on the ground. This GPS feature has been incorporated into a number of native applications and web based applications that incorporate the smart devices user's location. Examples include Groupon®, Facebook® Nearby, and Eventseeker. In each of the examples, the smart device user can be informed when he enters a specific set of coordinates about a particular discount at restaurant, a friend's proximity or a an entertainment event. The “GPS coordinates” demonstrates what one familiar with the art could do to enable the smart device to become a tracking beacon for periods of time that include until a target event occurs or the passage of a prescribed amount of time.

Using GPS signals, the students are identified while in a Retail store and join the contest through their electronic devices. In one embodiment each of the students is in the same location in another embodiment the students are in different locations. In another example, students can represent groups of students in classrooms or any group, such as a church group. In lieu of the GPS coordinates, the activity of the contest could include any type of membership program that could allow students or groups, to enroll and compete in the contest from remote locations, through the cloud.

The assessment and gateway functions may further comprise utilizing location based content and calculating the location of the user via, for example, the use of global positioning system (GPS) capabilities on the user's electronic computing device. The user may be required to perform a physical task (e.g. running around neighborhood, walking home from school at certain time and route) that is tracked by the user's device. Likewise, the content of the questions is location based. For example, a student walks into a math class 5 minutes before class starts and he would like to text. The gateway would be math themed questions of the day sponsored by the teacher of math questions customized to the student's current trends on tests and quizzes. And in a commercial setting, a customer at Starbucks® store or website might be asked a series of questions about the nutritional value of his most recent purchases. Further still, in an employment setting the employee may be asked a series of questions about laboratory safety or emergency exits as they move from one plant to another.

### GPS-Based Trigger for Locking and Unlocking Mechanism

The reward may be initiated by the global positioning service (GPS) of the electronic device and the relative location of the student using the electronic device. For example, in one case the student could be walking home from school and passing by a Starbucks. At such time, as he falls with a specific boundary of the GPS coordinates relative to the Starbucks a reward potential could be activated to induce the student to learn in exchange for an immediate reward upon completing a particular learning assignment. As a simple example, the student could complete a module on his SAT prep at the Starbucks and receive an immediate reward.

In another case, a random reward could be location based where for example if a student was walking by a retail sponsor they could be informed of a particular reward. In the location based award a set of GPS coordinates would be activated such that any electronic device traveling within such GPS coordinates triggers a reward such as drop into WalMart® store for a discount or a free soda.

### GPS-Based Check-Ins for Locking and Unlocking Mechanism

In another example of the invention, a third-party might require the device user on certain days of the week to (1) show up and check in to a specific location such as a school location by a certain time, (2) check in as still at school at the same location end of the school day, (3) check in at home by a certain time, (4) check in at home later in the evening to prove the user is still there. Rewards rules can be specified such as all four rules must be met for five days in a row to trigger a full allowance, or that for each check-in, $2 is accumulated into the allowance credits, or indeed, any number of other rules for rewards as described elsewhere. Each “check in session” could include specific unique learning questions or instructions that are customized to the end user to further confirm that the end user and the end user's device are in the specified coordinates requested by the third party.

### Electronic Device Usage/Credit Provided by Network Provider or Sponsor

In one scenario the student is provided a credit or full payment for their monthly service bill from their cell phone and/or cable carrier. The services that would be included would include all communications such as radio communications and satellite communications along with 2G to 4G Wi-Fi, cable and combinations as well. In a further example, the student is provided an electronic device and each day he earns time to access the features on the device in exchange for achieving targeted learning objectives. In a specific example, an at-risk child could be provided an electronic device and each incremental period such as a 24 hour period, a specific amount of learning content such as that related to the GED (general education diploma) would require a level of mastery in exchange for using the device for the incremental period. Further still, the results could be reported to third-party such as a sponsor or teacher or both.

### Anti-Cheating Mechanism

An electronic device could be programmed with a motion detection sensor such that the user has to keep both hands on the phone. In one case he would have his left hand under the phone and his right hand held against the home screen while he calculates the answer in his head. In other words, an intent of the anti-cheating is to prevent the user from going to another device, such as a calculator or a friends smart device to solicit the answer. If an unauthorized motion is detected then a new instruction or question could be generated. In another instance of anti-cheating mechanisms an optical tracking software such as the programs created by Tobii Technology, Inc. or the eye tracking software from Samsung Group in their Android 4.2 version. Using optical tracking if the user takes his eye off or away from the screen for a preset time such as 3 seconds then another instruction or question would be created for example.

In each case of an expected act of cheating, the result could be an immediate suspension of use, limited accessibility, reduced time, time subtracted, etc. These are only a few examples of how one familiar with the art of teaching and electronic device detection features would include in an anti-cheating mechanism.

### Compulsion Loop

Researchers and scientists are frequently publishing reports that refer to the new levels of addiction to electronic entertainment. For example, one study of more than 1,000 students from 10 countries and 12 universities concluded that the majority were not able to voluntarily forego their electronic connections for a mere 24 hours. In particular, the study found that these college students admitted to being “addicted” to modern technology such as mobile phones, laptops and television as well as social networking such as Facebook® and Twitter®.

Functional magnetic resonance imaging (fMRI) was used, in another study, to visualize which parts of the brain were engaged during certain aspects of social media. The overall conclusions were that the use of social media, and in particular expressing one's owns opinion, positively triggers dopamine reward pathways. The researchers even determined that many of the subjects would prefer reporting their own experiences to receiving a monetary reward.

Similar indications were noted in certain video gaming, which introduce high levels of “randomness” in reward granting as an intentional means of forming an addiction. The idea dates back decades and its used to create a compulsion loop that keeps the player engaging in the activity. The technique is referred to as the variable ratio of reinforcement (or operant conditioning). It is considered simple and powerful and is believed to be one of the reasons gambling is so addictive. This trend of operant conditioning has also led to a number of allegations that emailing possesses addictive characteristics. In fact, a new term of “emailoholics” emerged as the result of one author's studies. In this regard, using a random nature of rewards would entice the end users or students to engage in the invention. Further, having a system that enables a range of different reward types and levels is a targeted objective of this invention as well.

### Captive Marketing and Advertising

While the user is locked out of his phone (or electronic device) or participating in a contest while trying access to his phone, advertisers including the retailers have a captive audience for a host of different advertising options to those familiar with the art of on-line advertising and marketing on the world wide web. In one instance, the advertiser could use a retailers name in the form of the various questions, such as if one mocha from a Retailer costs $2.00 and a customer purchases five mochas, how much will the customer spend is an example of a question. Alternatively, if the Retailer's rewards card has $50.00 credit and a customer spends $17.50 what is the balance on the rewards card is another example of a question. Alternatively, banner adds could be placed or other features such as the mathematics content is brought to you a particular Retailer.

A critical feature of the locking mechanisms is the creation of a unique opportunity for targeted marketing that is used directly or indirectly with education, instruction or contest material. In such a case, advertisers would compensate the hosting cloud (or network) who is coordinating the introduction of the marketing material into the education content directly (or any parties working indirectly together or in combinations) as part of the question or as a separate advertisement. In yet another embodiment of the invention the separate advertisement may be accessible directly or only after another question or series of questions is generated on the display of the electronic device. Further still, the advertisers could rely on the nature of the content of the questions for the demographics of the targeted end user providing both a captive audience in combination with a demographically focused end user or group of end users. This example of a system and method of captive marketing and advertising is not limited to only these examples rather it is illustrative of one aspect of the current invention. The captive marketing mechanism could be integrated into each of the examples and illustrations included herein by one familiar with the relevant art.

In such a case, advertisers would compensate a hosting software who is coordinating the introduction of the marketing material into the education content directly as part of the question or as a separate advertisement. In yet another embodiment of the invention the separate advertisement may be accessible directly or only after another question or series of questions is generated. Further still, the advertisers could rely on the nature of the content of the questions for the demographic of the targeted user providing both a captive audience along with a demographically focused. This discussion of captive marketing in not limited to these examples rather its is illustrative of one aspect of the current invention.

The reward feature may be further exemplified and enhanced by the type of reward trigger, the reward types, the rewards redemption, reward gamesmanship, and reward providers. Below are specific examples of each and demonstrate the various types of individual activities that one familiar with the art could incorporate.

Rewards Triggers include: check-in at certain places such as school, third-party school reporting, extracurricular conditions/goals, completion of chores, school attendance, homework completion, direct teacher third party reporting, API to teacher server for tracking grades, API to school hosting server, accomplishing specified blocks of educational content, exposure to certain blocks/time periods of learning content (video, audio, ebook), incentives for study groups/studying content together with device users, group contests, educational content, extracurriculars—outside contests that specify device user(s) as meeting, criteria, and allot those rewards to qualifying user id's for redemption

Rewards Types include: Cumulative allowance credit, activated in portions for continued performance of criteria rules, Periodic allowance credit activated periodically for fulfilling minimum conditions, Third Party bestowal and third party can immediately bestow through portal for arbitrary things (mowing lawn, polite behavior, etc.)

Rewards Redemption include: partnership with Square, Inc. and/or other mobile payment apps/companies, partnership with credit card company—puts money right on a debit card credits stored as data which work toward participating partner programs, partnerships with vendors/sponsors, and programs/contests at school or other third parties

Rewards Gamesmanship include: students can double down (or specified extra reward) with rewards by completing extra credit education content, students can risk losing x and stand to gain y, by attempting harder extra credit, question(s) which proved an A+ level of excellence in learning the material, a special Third Party at any “real life” gamesmanship can be designated to be, the “decider” of an award or contest, for example, for a sprint, or a talent, show, and immediately bestow the award to the user via their user id to a portal or directly using his device and the user's device through application on each device using NFC or QR code or what not.

Rewards Providers include: Vendors, Schools/institutions and Third Party (parent)—selects a goal such as bicycle, wherein transaction using THEIR credit card gets unlocked by meeting rewards triggers/criteria. One familiar with the art would understand how these can be incorporated into the various reward features illustrated elsewhere in this document.

### Toys and Other Devices

The features discussed in various embodiments may also be used in conjunction with existing interactive toys and robots. For standalone toys and robots, and other electronic computing devices that are not connected to a network, the educational software is installed on the device, toy, or robot and coded to be compatible with the specific device and any other computer software associated with it. As a result, the user would have to successfully execute the testing modules of the present invention in order to gain access to the device, toy, or robot. And for interactive toys, robots, and other electronic computing devices connected to a network, the Educational software is downloaded to the device, toy, or robot, or accessible via the Question & Answer (Q & A) system server; and is coded to be compatible with the specific device, toy, or robot and any other software associated with it (e.g. toy mobile app). In other instances the interactive toys can be turned off by failing to complete the targeted objectives or the interactive toys level of interaction can be based on the advancement of the learning modules within the framework of this invention.

The features discussed in various embodiments can be integrated into these “smart” features in the car and will thusly disable the features in the car directly through the target electronic devices or into the separate software of the vehicle using API or other means well known to those in the art.

FIG. 14 contains a high-level block diagram showing an example architecture of a computer, which may represent any electronic device, any server, or any node within a cloud service as described herein. The computer 1400 includes one or more processors 1410 and memory 1420 coupled to an interconnect 1430. The interconnect 1430 shown in FIG. 14 is an abstraction that represents any one or more separate physical buses, point to point connections, or both connected by appropriate bridges, adapters, or controllers. The interconnect 1430, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1494 bus, also called “Firewire”.

The processor(s) 1410 is/are the central processing unit (CPU) of the computer 1400 and, thus, control the overall operation of the computer 1400. In certain embodiments, the processor(s) 1410 accomplish this by executing software or firmware stored in memory 1420. The processor(s) 1410 may be, or may include, one or more programmable general-purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or the like, or a combination of such devices.

The memory 1420 is or includes the main memory of the computer 1400. The memory 1420 represents any form of random access memory (RAM), read-only memory (ROM), flash memory, or the like, or a combination of such devices. In use, the memory 1420 may contain code 1470 containing instructions according to the techniques disclosed herein.

Also connected to the processor(s) 1410 through the interconnect 1430 are a network adapter 1440 and a storage adapter 1450. The network adapter 1440 provides the computer 1400 with the ability to communicate with remote devices over a network and may be, for example, an Ethernet adapter or Fibre Channel adapter. The network adapter 1440 may also provide the computer 1400 with the ability to communicate with other computers. The storage adapter 1450 allows the computer 1400 to access a persistent storage, and may be, for example, a Fibre Channel adapter or SCSI adapter.

The code 1470 stored in memory 1420 may be implemented as software and/or firmware to program the processor(s) 1410 to carry out actions described above. In certain embodiments, such software or firmware may be initially provided to the computer 1400 by downloading it from a remote system through the computer 1400 (e.g., via network adapter 1440).

### CONCLUSION

The techniques introduced herein can be implemented by, for example, programmable circuitry (e.g., one or more microprocessors) programmed with software and/or firmware, or entirely in special-purpose hardwired circuitry, or in a combination of such forms. Software or firmware for use in implementing the techniques introduced here may be stored on a machine-readable storage medium and may be executed by one or more general-purpose or special-purpose programmable microprocessors.

In addition to the above mentioned examples, various other modifications and alterations of the invention may be made without departing from the invention. Accordingly, the above disclosure is not to be considered as limiting, and the appended claims are to be interpreted as encompassing the true spirit and the entire scope of the invention.

The various embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

What is claimed is:

1. A method performed by a multi-device control system, which communicates with a plurality of client devices through a cloud-computing platform, the method comprising:
receiving a first request for a first reward from a first of the plurality of client devices;
transmitting a task to the first client device;
receiving a task performance result from the first client device;
determining whether the received task performance result matches an expected task performance result for the transmitted task;
when the determination result is positive, delivering the first reward to the first client device;
receiving a second request for a second reward from a second of the plurality of client devices after the first request is received and before the first reward is delivered to the first client device; and
a notifying unit configured to notify the second client device that the second reward is unavailable.

2. The method of claim 1, wherein
the transmitting includes receiving the task from an education system connected to the cloud-computing platform and transmitting the received task to the first client device; and
the determining includes sending the received task performance result to the education system and receiving the determination result of whether the received task performance result matches the expected task performance result from the education system.

3. The method of claim 1, wherein the plurality of client devices includes a smart mobile electronic device.

4. The method of claim 1, wherein the first reward is an authorization for access of features of the first client device, and the second reward is an authorization for access of features of the second client device.

5. The method of claim 1, further comprising transmitting a task to the second client device after the first reward is delivered to the first client device.

6. The method of claim 1, further comprising delivering the second reward to the second client device after the first reward is delivered to the first client device.

7. A multi-device control system which communicates with a plurality of devices through a cloud-computing platform, the system comprising:
a marking unit configured to mark all parts of a task unfinished;
a transmitting unit configured to transmit the task to all the devices;
an update unit configured to receive an update that a portion of the task is finished from a first of the devices;
a determining unit configured to determine whether any part of the portion is marked unfinished and whether the task is completed;
a notifying unit configured to,
when the determination result indicates that the task is completed, inform all the devices that the task is completed and a reward is available, and
when the determination result indicates that at least one part of the portion is marked unfinished, mark the at least one part finished and notify all the devices that parts of the task are finished.

8. The multi-device control system of claim 7, further comprising
a receiving unit configured to receive a request from a second of the plurality of devices for the reward; and
a delivering unit configured to deliver the reward to the second device.

9. The multi-device control system of claim 7, wherein the plurality of devices includes a cellular phone, a tablet, a personal digital assistant, a laptop, a desktop computer, a wearable device, a television, or a gaming station.

10. A device which communicates with a multi-device control server though a cloud-computing platform, the device comprising:
a task receiving unit configured to receive a task from the multi-device control server;
a first update unit configured to receive a first update from the multi-device control server that a portion of the task is finished;
a progress unit configured to allow a user to work on an unfinished portion of the task;
a notifying unit configured to notify the multi-device control server that a portion of the task worked on by the user is now finished; and
a second update unit configured to receive a second update from the multi-device control server that the task is completed and a reward is available.

11. The device of claim 10, wherein the notifying unit notifies the multi-device control server periodically or when a predetermined amount of the task is performed.

12. The device of claim 10, further comprising:
a request unit configured to receive a request from a user for a reward; and
a reward unit configured to receive the requested reward from the multi-device control server and present the received reward to the user, wherein
the task is received in response to receiving the request, and
the second update indicates that the requested reward is available and is received before the reward unit receives the requested reward.

13. A method of controlling access of a plurality of smart mobile devices of a user using a hierarchy of rewards, comprising:
associating a reward at each level of the hierarchy with a task;
transmitting the task associated with the reward at a current level to one of the smart mobile devices only after delivering the reward at a previous level; and
delivering the reward at a current level to one of the smart mobile devices only after the task associated with the reward at the current level is completed by the user,
wherein the reward at the first level is an authorization for access of a native function of a first of the smart mobile devices.

14. The method of claim 13, wherein the reward at the second level is an authorization for access of an application installed on the first smart mobile device.

15. The method of claim 13, wherein the reward at the second level is an authorization for access of a native function of a second of the smart mobile devices.

16. The method of claim 15, wherein the second smart mobile device is associated with a higher level of addicted usage than the first smart mobile device.

17. The method of claim 13, wherein the reward at a previous level is an authorization for using a document processing application installed on the first smart mobile device with document-reading permissions, and the reward at a current level is an authorization for using the document processing application with document-reading and document-writing permissions.

18. The method of claim 13, wherein the reward at a previous level is an authorization for using an email application installed on the first smart mobile device, and the reward at a current level is an authorization for using a social media application installed on one of the smart mobile devices.

19. The method of claim 13, wherein the task associated with the reward at a previous level is easier than the task associated with the reward at a current level.

20. The method of claim 13, wherein the native function of the first smart mobile device is phone calling, emailing, texting, or Internet access.

21. The method of claim 13, further comprising notifying a third party after delivering the reward at a current level or when the task associated with the reward at the current level is completed by the user.

22. A method of controlling access to an electronic device, comprising:
disabling access to one or more of a plurality of native functions of the electronic device;
disabling access to one or more of a plurality of applications installed on the electronic device;
disabling access to Internet resources from the electronic device by performing one or more of a plurality of tasks on the electronic device, including:
(1) modifying a security firewall to selectively disable Internet access,
(2) using a proxy server to replace data received from the Internet by a notification of disabled access,
(3) disabling networking hardware,
(4) adjusting DNS server to redirect Internet traffic for further processing, and
(5) killing networking processes that are not required by an operating system; and
allowing a user to complete a learning process to restore access to one or more of the plurality of native functions, the plurality of applications, and the Internet resources, wherein access to the Internet resources is enabled by terminating performance of one or more of the plurality of tasks.
